(19) United States
(12) Patent Application Publication
(10) Pub. No.: US 2026/0149060 A1
(43) Pub. Date: May 28, 2026

(54) Devices, Systems, and Methods for Rejuvenating Energy Devices

(71) Applicant: Sonocharge Energy, Inc, Mountain View, CA (US)

(72) Inventors: An HUANG, San Diego, CA (US); Haodong LIU, San Diego, CA (US); Ping LIU, San Diego, CA (US); Jianbin ZHOU, San Diego, CA (US)

(21) Appl. No.: 19/453,081

(22) Filed: Jan. 20, 2026

Related U.S. Application Data
(63) Continuation of application No. PCT/US24/38337, filed on Jul. 17, 2024.
(60) Provisional application No. 63/514,291, filed on Jul. 18, 2023.

(51) Int. Cl. H01M 10/42; H01M 10/0525; H01M 10/054

(52) U.S. Cl. CPC H01M 10/4242; H01M 10/0525; H01M 10/054

(57) ABSTRACT

Provided are devices, systems, and methods for rejuvenating degraded energy devices. In one aspect, the present disclosure provides a method for rejuvenating an energy device, the method comprising: using at least one acoustic device to generate acoustic waves to facilitate flow and/or distribution of fresh or unused chemicals into the energy device and to replace and expel aged or used chemicals out of the energy device, thereby rejuvenating the energy device and rendering the energy device suitable for continued usage.

### CROSS REFERENCE

This application is a continuation of PCT/US2024/038337, filed on 2024 Jul. 17, which claims the benefit of U.S. Provisional Application No. 63/514,291, filed 2023 Jul. 18, both of which are entirely incorporated herein by reference.

### BACKGROUND

The surge in global demand for energy over the last decades has spurred a concurrent demand for high-capacity and long-lasting energy devices to meet present and future global energy demand.

Traditional methods of recycling energy devices, such as batteries, often involve pyrometallurgical, hydrometallurgical, or direct recycling processes. While these methods have been utilized, they come with their own set of challenges when it comes to recycling materials effectively.

### SUMMARY

Provided herein are devices, systems, and methods for rejuvenating used or degraded energy devices. The devices, systems, and methods described herein may improve the cost efficiency of rejuvenating energy devices. The devices, systems, and methods described herein may extend the service life of the energy devices.

In some embodiments, the present disclosure provides a method for rejuvenating an energy device, the method comprising: using at least one acoustic device to generate acoustic waves to facilitate flow and/or distribution of fresh or unused chemicals into the energy device and to replenish, replace and expel aged or used chemicals out of the energy device, thereby rejuvenating the energy device and rendering the energy device suitable for continued usage.

In some embodiments, rejuvenating the energy device comprises restoring the capacity of the energy device to a desired capacity. In some embodiments, rejuvenating the energy device comprises increasing the capacity of the energy device by at least 1%. In some embodiments, rejuvenating the energy device comprises restoring a capacity of the energy device to at least 60% of an original capacity of the energy device. In some embodiments, the energy device has less than 60% of its original capacity prior to rejuvenation, and greater than 60% of its original capacity after rejuvenation. In some embodiments, the aged or used chemicals comprise a used electrolyte, and the fresh or unused chemicals comprise a fresh unused electrolyte. In some embodiments, the aged or used chemicals are provided in a semi-solid, gel or liquid form factors. In some embodiments, the fresh or unused chemicals are provided in a semi-solid or gel or a liquid form factor.

In some embodiments, the method further comprises: using the at least one acoustic device to generate acoustic waves to reduce an amount, thickness, or non-uniformity of one or more interphase layers within the energy device. In some embodiments, rejuvenating the energy device comprises forming homogenous or uniform stable interphase layers within the energy device. In some embodiments, the interphase layers comprise a solid electrolyte interphase (SEI) and a cathode electrolyte interphase (CEI). In some embodiments, the energy device is capable of being rejuvenated while being agnostic to an electrochemical cell chemistry and/or geometry of the energy device.

In some embodiments, the method further comprises: using the at least one acoustic device to generate and stream the acoustic waves to replenish ions to a positive or negative electrode of the energy device to restore an ionic concentration within the energy device.

In some embodiments, the ions are replenished to the positive or negative electrode of the energy device via intercalation, conversion, alloying, or plating.

In some embodiments, the energy device comprises one or more inlets and one or more outlets, and wherein the aged or used chemicals are expelled from the energy device through the one or more outlets, and the fresh or unused chemicals are flown into the energy device through the one or more inlets. In some embodiments, one or more outlets comprise a resealable opening. In some embodiments, one or more inlets comprise a resealable opening. In some embodiments, the one or more inlets comprise a first resealable opening, and the one or more outlets comprise a second resealable opening. In some embodiments, the one or more inlets and the one or more outlets are located at opposite ends, or the same ends, or at any locations on the cell of the energy device. In some embodiments, the energy device comprises a resealable opening configured to (i) flow the fresh or unused chemicals into the energy device and (ii) expel the aged or used chemicals out of the energy device.

In some embodiments, the energy device is rejuvenated without requiring the disassembly of the energy device. In some embodiments, the energy device is rejuvenated with disassembly of the energy device. In some embodiments, a cell of the energy device is opened, and a casing is removed. In some embodiments, the rejuvenating is performed on a core of the energy device. In some embodiments, the core is put into a new casing, and the cell is reassembled to form a rejuvenated energy device.

In some embodiments, using the at least one acoustic device enables the energy device to be rejuvenated within a duration ranging from 0.1 hours to 168 hours. In some embodiments, the energy device comprises one or more electrochemical cells. In some embodiments, the one or more electrochemical cells comprise one or more different cell chemistries. In some embodiments, the one or more electrochemical cells comprise one or more liquid electrolyte batteries. In some embodiments, the one or more electrochemical cells comprise a solid-state or semi-solid-state battery. In some embodiments, the one or more electrochemical cells comprise a lithium-ion battery and/or a lithium metal battery. In some embodiments, the one or more electrochemical cells comprise a sodium-ion battery and/or a sodium metal battery. In some embodiments, the one or more electrochemical cells comprise a lead-acid battery.

In some embodiments, the acoustic waves comprise at least one of the following: surface acoustic waves (SAW), Lamb waves, Love waves, flexural waves, thickness mode vibrations, mixed-mode waves, longitudinal waves, shear mode vibrations, bulk wave vibrations, standing wave vibrations, or any combination(s) thereof. In some embodiments, the at least one acoustic device is attached to an exterior and/or interior of the energy device. In some embodiments, the at least one acoustic device is attached to one or more suitable or predefined locations on the energy device. In some embodiments, the energy device has different form factors comprising coin cells, pouch cells, cylindrical cells, prismatic cells, or cells having one or more irregular shapes. In some embodiments, the energy device has different energies, ranging from 1 mWh to 1 MWh. In some embodiments, the acoustic waves have a frequency ranging from 10 hertz (Hz) to 500 megahertz (MHz). In some embodiments, the acoustic waves have a fixed frequency. In some embodiments, the frequency of the acoustic waves is varied. In some embodiments, the acoustic waves have a power ranging from 0.1 milliwatts (mW) to 500 megawatts (MW). In some embodiments, the acoustic waves have a fixed power. In some embodiments, the power of the acoustic waves is varied. In some embodiments, the method comprises expelling aged or used chemicals out of the energy device by a solvent. In some embodiments, the method comprises flowing fresh or unused chemicals into the energy device subsequent to the expelling.

In some embodiments, the present disclosure provides a method for rejuvenating an energy device, the method comprising: using at least one acoustic device to generate acoustic waves to facilitate flow and/or distribution of electrolytes in the energy device, thereby rejuvenating the energy device without opening cells of the energy device and rendering the energy device suitable for continued usage.

In some embodiments, rejuvenating the energy device comprises restoring a capacity of the energy device to a desired capacity. In some embodiments, rejuvenating the energy device comprises increasing a capacity of the energy device by at least 1%. In some embodiments, rejuvenating the energy device comprises restoring a capacity of the energy device to at least 80% of an original capacity of the energy device. In some embodiments, the energy device has less than 80% of its original capacity prior to rejuvenation, and greater than 80% of its original capacity after rejuvenation.

In some embodiments, the method further comprises: using the at least one acoustic device to generate acoustic waves to reduce an amount, thickness, or non-uniformity of one or more interphase layers within the energy device. In some embodiments, rejuvenating the energy device comprises forming homogenous or uniform stable interphase layers within the energy device. In some embodiments, the interphase layers comprise a solid electrolyte interphase (SEI) and a cathode electrolyte interphase (CEI). In some embodiments, the energy device is capable of being rejuvenated while being agnostic to an electrochemical cell chemistry and/or geometry of the energy device.

In some embodiments, the method further comprises: using the at least one acoustic device to generate and stream the acoustic waves to replenish ions to a positive or negative electrode of the energy device to restore an ionic concentration within the energy device.

In some embodiments, the ions are replenished to the positive or negative electrode of the energy device via intercalation, conversion, alloying, or plating. In some embodiments, using the at least one acoustic device enables the energy device to be rejuvenated within a duration ranging from 0.1 hours to 168 hours.

In some embodiments, the energy device comprises one or more electrochemical cells. In some embodiments, one or more electrochemical cells comprise one or more different cell chemistries. In some embodiments, the one or more electrochemical cells comprise one or more liquid electrolyte batteries. In some embodiments, the one or more electrochemical cells comprise a solid-state or semi-solid-state battery. In some embodiments, the one or more electrochemical cells comprise a lithium-ion battery and/or a lithium metal battery. In some embodiments, the one or more electrochemical cells comprise a sodium-ion battery and/or a sodium metal battery. In some embodiments, the one or more electrochemical cells comprise a lead-acid battery.

In some embodiments, the acoustic waves comprise at least one of the following: surface acoustic waves (SAW), Lamb waves, Love waves, flexural waves, thickness mode vibrations, mixed-mode waves, longitudinal waves, shear mode vibrations, bulk wave vibrations, standing wave vibrations, or any combination(s) thereof. In some embodiments, the at least one acoustic device is attached to an exterior and/or interior of the energy device. In some embodiments, the at least one acoustic device is attached to one or more suitable or predefined locations on the energy device. In some embodiments, the energy device has different form factors comprising coin cells, pouch cells, cylindrical cells, prismatic cells, or cells having one or more irregular shapes.

In some embodiments, the energy device has different energies, ranging from 1 mWh to 1 MWh. In some embodiments, the acoustic waves have a frequency ranging from 10 hertz (Hz) to 500 megahertz (MHz). In some embodiments, the acoustic waves have a fixed frequency. In some embodiments, the frequency of the acoustic waves is varied. In some embodiments, the acoustic waves have a power ranging from 0.1 milliwatts (mW) to 500 megawatts (MW). In some embodiments, the acoustic waves have a fixed power. In some embodiments, the power of the acoustic waves is varied.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a lifecycle of an energy device, in accordance with some embodiments of the disclosure;

FIGS. 2A and 2B show exemplary states of the energy device, in accordance with some embodiments of the disclosure;

FIG. 3A shows an exemplary energy device, in accordance with some embodiments of the disclosure;

FIG. 3B shows an acoustic device interfaced with an energy device and the working mechanism, in accordance with some embodiments of the disclosure;

FIGS. 4A-4L illustrate configurations of an irregularly shaped cell, such as a cylindrically shaped cell, in communication with an acoustic module, in accordance with some embodiments of the disclosure;

FIG. 5 illustrates a computer system in communication with the acoustic devices, acoustic modules, and/or energy devices, in accordance with some embodiments of the disclosure;

FIG. 6A shows an exemplary setup for the rejuvenation process, in accordance with some embodiments of the disclosure;

FIG. 6B shows the electrochemical impedance spectroscopy (EIS) test results at different rejuvenation time for the cell rejuvenated without SAW, in accordance with some embodiments of the disclosure;

FIG. 6C shows the EIS test results at different rejuvenation time for the cell rejuvenated with SAW, in accordance with some embodiments of the disclosure;

FIG. 6D shows the solid electrolyte interphase (SEI) resistance of the cell after different rejuvenation time with and without SAW, in accordance with some embodiments of the disclosure;

FIG. 6E shows the capacity of the pristine cell, the cell rejuvenated with SAW, and the cell rejuvenated without SAW, during charge and discharge cycling, in accordance with some embodiments of the disclosure;

FIG. 6F shows the capacity retention (capacity divided by the original capacity or maximum capacity) of the pristine cell, the cell rejuvenated with SAW, and the cell rejuvenated without SAW, during charge and discharge cycling, in accordance with some embodiments of the disclosure;

FIG. 7A shows an exemplary setup for the rejuvenation process, in accordance with some embodiments of the disclosure;

FIG. 7B shows an exemplary setup for an electrochemical lithiation to further replenish the electrode with Li ions, in accordance with some embodiments of the disclosure;

FIG. 7C shows the EIS test results at different rejuvenation time for the cell rejuvenated without SAW, in accordance with some embodiments of the disclosure;

FIG. 7D shows the EIS test results at different rejuvenation time for the cell rejuvenated with SAW, in accordance with some embodiments of the disclosure;

FIG. 7E shows the SEI resistance of the cell after different rejuvenation time with and without SAW, in accordance with some embodiments of the disclosure;

FIG. 7F shows the capacity of the pristine cell, used cell, cell rejuvenated without SAW, cell rejuvenated with SAW, and cell rejuvenated with SAW and further Li replenishment in the cathode, in accordance with some embodiments of the disclosure;

FIG. 7G shows the 1^{st} discharge curves and the 1^{st} charge curves for the pristine cell, used cell, cell rejuvenated without SAW, cell rejuvenated with SAW, and cell rejuvenated with SAW and further Li replenishment in the cathode, in accordance with some embodiments of the disclosure;

FIG. 7H shows the capacity retention of the pristine cell, cell rejuvenated without SAW, cell rejuvenated with SAW, and cell rejuvenated with SAW and further Li replenishment in the cathode, in accordance with some embodiments of the disclosure;

FIG. 8A shows the capacity retention of the pristine cell and the rejuvenated cell during a 1 C/1 C cycling, in accordance with some embodiments of the disclosure;

FIG. 8B shows the 73^{rd} discharge/charge cycle and the 74^{th} discharge/charge cycle, in accordance with some embodiments of the disclosure;

FIG. 9 shows an exemplary setup for electrochemical lithiation, in accordance with some embodiments of the disclosure;

FIG. 10A shows an exemplary pouch cell with an extra sealing bag area, in accordance with some embodiments of the disclosure;

FIG. 10B shows another exemplary pouch cell with an extra sealing bag area, in accordance with some embodiments of the disclosure;

FIG. 11A shows an exemplary prismatic cell with a resealable cap, in accordance with some embodiments of the disclosure; and

FIG. 11B shows another exemplary prismatic cell with a resealable cap, in accordance with some embodiments of the disclosure.

### DETAILED DESCRIPTION

While various embodiments have been shown and described herein, such embodiments are provided by way of example only. Numerous variations, changes, and substitutions may occur without departing from the present disclosure. It should be understood that various alternatives to the embodiments described herein may be employed.

Unless defined otherwise, all technical and scientific terms used herein have the same meaning as commonly understood, to which the present disclosure belongs. In case of conflict, the present application, including the definitions, will control. Also, unless otherwise required by context, singular terms shall include pluralities and plural terms shall include the singular.

Provided herein are devices, systems, and methods for rejuvenating an energy device. In some embodiments, the energy device is used. In some embodiments, the energy device may be degraded. In some embodiments, the energy device may be spent. In some embodiments, the energy device can be an energy storage device. In some embodiments, the energy device can be a battery.

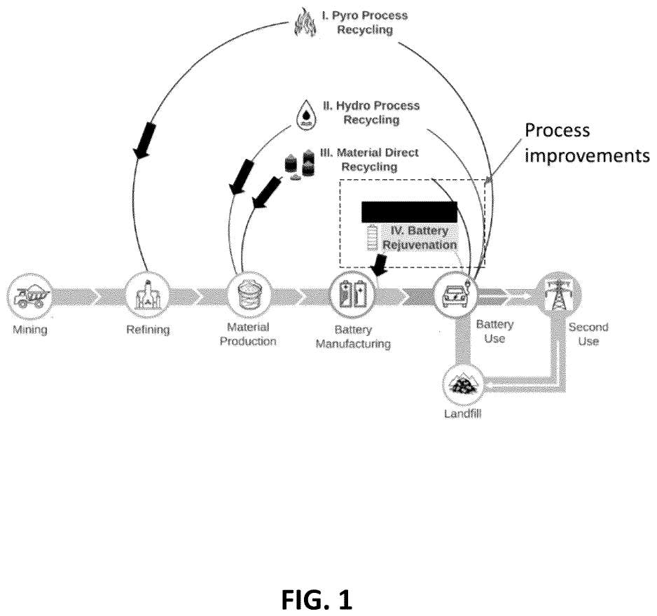

FIG. 1 shows the lifecycle of an energy device, e.g., a battery. Raw materials of an energy device can be mined and refined through mining and refining processes. Through material production processes, the raw materials can be transformed into materials that can be manufactured into the energy device. Through a manufacturing process, the materials can be manufactured into energy devices, and/or a pack or module of energy devices. The energy device, after use, may lose performance due to loss of active electrolyte (e.g., ions) and/or increased interphase layers (e.g., by side reactions). In some cases, after the usage of the energy devices, e.g., in automotive, the used energy devices can be used in other systems. In some cases, the used batteries may not have sufficient capacity to power an automotive, but they can be used for other applications, e.g., a stationary storage system, or in combination with renewable energy generation, e.g., wind or solar, or to supply services to the electricity network. This is referred to as the “second use” of an energy device. In some cases, the used or spent energy device may be disposed of in a landfill.

In some cases, the used or spent energy devices can be recycled. The recycling of an energy device can comprise a pyro recycling process or a pyrometallurgical process in which the energy device can be disassembled to separate cells and subjected to a treatment with high temperature heating. The recycling of an energy device can comprise a hydro recycling process or hydrometallurgical process in which the energy device can be disassembled to separate cells and subjected to a treatment with a leaching solution, e.g., an acidic solution. The recycling of an energy device can comprise a material direct recycling process in which the energy device can be disassembled, broken or crushed, sorted, and cleaned. The traditional recycling of energy devices may have high energy consumption and low recovery efficiency. In some cases, the traditional recycling process may produce toxic gases (e.g., dioxins, furans, etc.). In some cases, the recycled materials of the traditional recycling processes may not achieve the long-term properties of the new material. There is a need for a new recycling process that is efficient, cost-effective, does not require high energy consumption, and does not produce toxic materials.

The devices, systems, and methods described in the present disclosure can rejuvenate an energy device, e.g., a used or spent energy device. The used or spent energy device, after the rejuvenation, can be reused, which can largely reduce the global environmental impact (e.g., reducing greenhouse gas emission, reducing waste production, etc.) associated with extracting, processing, and manufacturing the materials used in the energy devices. With the rejuvenation, the lifespan of the energy device can be extended. This not only reduces the need for raw material extraction but also minimizes the energy-intensive processes involved in manufacturing new devices or the recycling process. The result is a more sustainable approach to energy storage that aligns with the principles of resource conservation and environmental responsibility. The ability to reuse and rejuvenate energy devices provides significant benefits for the industry and the planet. The devices, systems, and methods provided in this disclosure can help to minimize waste, conserve resources, and reduce the carbon footprint associated with the production and disposal of these devices. The devices, systems, and methods provided in this disclosure provide a non-destructive process to enhance the performance of the energy device. The devices, systems, and methods provided in this disclosure can maintain the structural integrity of the energy device. The devices, systems, and methods provided in this disclosure offer a promising avenue for achieving a more sustainable and circular economy in the field of energy storage.

In some embodiments, the method can enable reversible sealing of the energy device. In some embodiments, the method can comprise replacing degraded electrolyte with fresh electrolyte in the energy device. In some embodiments, the method can comprise washing degraded electrolyte out of the energy device using a solvent. In some embodiments, the method can reduce electrode interphase side products. In some embodiments, the method can reduce the thickness of a cathode electrolyte interphase (CEI) layer. In some embodiments, the method can reduce the thickness of a solid electrolyte interphase (SEI) layer. In some embodiments, the method can reduce the thickness of a CEI layer and an SEI layer. In some embodiments, the method can wash out side-reaction products in a cathode electrolyte interphase, a solid electrolyte interphase, or a cathode electrolyte interphase and a solid electrolyte interphase. In some embodiments, the method can comprise replenishing ions (e.g., Li⁺ ions) to the cathode. In some embodiments, the method can comprise replenishing ions (e.g., Li⁺ ions) to the cathode to complete the rejuvenation process. In some embodiments, the method can comprise replenishing ions (e.g., Li⁺ ions) to the anode. In some embodiments, the method can comprise replenishing ions (e.g., Li⁺ ions) to the anode to complete the rejuvenation process. In some embodiments, the method can have greater capacity recovery as compared to other methods (e.g., direct recycling methods). In some embodiments, the capacity recovery can be greater than about 85%, greater than about 90%, greater than about 95%, greater than about 96%, greater than about 97%, greater than about 98%, greater than about 99%, or more. In some embodiments, the method can extend the service life and improve the longevity of the energy device. In some embodiments, the method can extend the service life by at least about 5%, at least about 10%, at least about 20%, at least about 30%, at least about 40%, at least about 50%, at least about 60%, at least about 70%, at least about 80%, at least about 90%, or more. In some embodiments, the method can extend the discharge/charge cycles by at least 100, at least 200, at least 300, at least 500, at least 1000, at least 2000, at least 3000, at least 4000, at least 5000, at least 10000, or more. In some embodiments, the method can increase the delivered energy of an energy device by at least about 5%, at least about 10%, at least about 20%, at least about 30%, at least about 40%, at least about 50%, at least about 60%, at least about 70%, at least about 80%, at least about 90%, or more. In some embodiments, the method can reduce the cost for recycling by at least about 5%, at least about 10%, at least about 20%, at least about 30%, at least about 40%, at least about 50%, at least about 60%, at least about 70%, at least about 80%, at least about 90%, or more. In some embodiments, the method can reduce the energy device lifetime greenhouse gas emission by at least about 5%, at least about 10%, at least about 20%, at least about 30%, at least about 40%, at least about 50%, at least about 60%, at least about 70%, at least about 80%, at least about 90%, or more. In some embodiments, the method can reduce the energy device lifetime greenhouse gas emission to 8.4 to 10.0 kg CO₂/kWh energy delivered. In some embodiments, the rejuvenated energy device (e.g., batteries) can deliver greater than 4 Ah capacity, with specifications surpassing 260 Wh/kg, and over 1568 kWh/kg in total lifetime energy delivery. In some embodiments, the rejuvenation cost can be at most about 40%, at most about 30%, at most about 20%, at most about 10%, at most about 5%, or less of the initial energy device cost.

In some embodiments, the present disclosure provides a method for rejuvenating an energy device. In some embodiments, the method comprises: using at least one acoustic device to generate acoustic waves to (i) facilitate flow and/or distribution of fresh or unused chemicals into the energy device and (ii) replace and expel aged or used chemicals out of the energy device, thereby rejuvenating the energy device. The rejuvenated energy device can be suitable for continued usage.

In some embodiments, the energy device can be rejuvenated multiple times, e.g., one time, two times, three times, four times, five times, or more times. In some embodiments, each rejuvenation can restore the capacity to at least about 80%, at least about 85%, at least about 90%, at least about 95%, at least about 97%, at least about 98%, at least about 99%, or more. In some embodiments, each rejuvenation can extend the service life (e.g., additional cycles) by at least about 50%, at least about 60%, at least about 70%, at least about 80%, at least about 90%, at least about 95%, or more. Table 1 shows exemplary capacity and cycle number (e.g., energy device being used to about 80% capacity) of an energy device after rejuvenation.

TABLE 1
Exemplary capacity and cycle number of an energy device.

| | Initial | 1st | 2nd | 3rd | 4th | |
|---|---|---|---|---|---|---|
| | (pristine cell) | rejuvenation | rejuvenation | rejuvenation | rejuvenation | Total |
| Capacity (%) | 100 | 98 | 96 | 94.1 | 92.2 | |
| Cycle number to | 1500 | 1350 | 1203 | 1059 | 918 | 6030 |
| 80% capacity | | | | | | |

In some embodiments, a plurality of energy devices can be rejuvenated in parallel. In some embodiments, the plurality of energy devices can be coupled to a common acoustic device or a plurality of acoustic devices. In some embodiments, the plurality of acoustic devices can be integrated and connected to a printed circuit board (PCB) device.

In some embodiments, the energy device can be disassembled before the rejuvenation. In some embodiments, the cells of the energy device can be separated and opened. In some embodiments, the casing can be removed. In some embodiments, the rejuvenation can be performed to the cores (e.g., jelly rolls) of the cells. In some embodiments, after the rejuvenation, the cores can be put into the casing or a new casing, and the cells can be re-assembled to form the energy device.

In some embodiments, the energy device can comprise one or more inlets and one or more outlets. In some embodiments, aged or used chemicals (e.g., electrolytes) can be expelled from the energy device through the one or more outlets. In some embodiments, fresh or unused chemicals can be flown into the energy device through one or more inlets. In some embodiments, an inlet for flowing the fresh or unused chemicals into the energy device may be used as an outlet for expelling the aged or used chemicals out of the energy device. In some embodiments, the acoustic waves can improve the movement of the fresh or unused chemicals in the energy device.

In some embodiments, the inlet and the outlet can be located at opposite ends of the cell of the energy device. In some embodiments, the inlet and the outlet can be located at the same ends of the cell of the energy device. In some embodiments, the inlet and the outlet can be located at any two suitable locations on the cell of the energy device. In some embodiments, the inlet and/or the outlet can be located at a top surface, a bottom surface, a front surface, a back surface, and/or a side surface of the energy device (e.g., a cell of the energy device).

In some embodiments, the one or more outlets can comprise a resealable opening. In some embodiments, the one or more inlets can comprise a resealable opening. In some embodiments, the one or more inlets can comprise a first resealable opening, and the one or more outlets can comprise a second resealable opening. In some embodiments, a resealable opening can serve as both an inlet and an outlet. In some embodiments, the resealable opening can be located at a top surface, a bottom surface, a front surface, a back surface, and/or a side surface of the energy device (e.g., a cell of the energy device). In some embodiments, the cell may not have an opening.

In some embodiments, the rejuvenation can be performed without opening the cell. In some embodiments, the rejuvenation can be performed in-situ. In some embodiments, the in-situ rejuvenation may be performed without opening the cell. In some embodiments, the in-situ rejuvenation may be performed by applying acoustic waves to the cell. In some embodiments, the acoustic waves applied to the cell can agitate the electrolyte in the cell and reduce the CEI and SEI layers (e.g., thickness and volume). In some embodiments, the in-situ rejuvenation can be performed when the capacity of the energy device is below about 90%, below about 85%, below about 80%, or lower of the fresh energy device. In some embodiments, the in-situ rejuvenation can improve the capacity by at least about 1%, at least about 5%, at least about 10%, at least about 20%, at least about 30%, at least about 40%, at least about 50%, at least about 60%, at least about 70%, at least about 80%, at least about 90%, or more. In some embodiments, the in-situ rejuvenation can be performed multiple times during the lifetime of the energy device.

In some embodiments, the present disclosure provides a method for rejuvenating an energy device, the method comprising: using at least one acoustic device to generate acoustic waves to facilitate flow and/or distribution of electrolytes in the energy device, thereby rejuvenating the energy device without opening cells of the energy device and rendering the energy device suitable for continued usage.

In some embodiments, the energy device can comprise a sensor or detector to monitor one or more parameters of the energy device and a change of the one or more parameters. In some embodiments, the one or more parameters may comprise a capacity, a bulk impedance, an interphase impedance, or a thickness of interphase layers.

In some embodiments, if a change in the one or more parameters of the energy device is greater than about 5%, greater than about 10%, greater than about 15%, greater than about 20%, greater than about 25%, greater than about 30%, greater than about 40%, greater than about 50%, or more, the controller may send a signal to the acoustic device to generate and transmit acoustic waves to the energy device for an in-situ rejuvenation. In some embodiments, the in-situ rejuvenation can be performed from 0.1 h to 1 h, from 0.1 h to 5 h, from 0.1 h to 10 h, from 0.1 h to 20 h, from 0.1 h to 30 h, from 0.1 h to 50 h, from 0.1 h to 100 h, from 0.1 h to 168 h, from 1 h to 5 h, from 1 h to 10 h, from 1 h to 20 h, from 1 h to 30 h, from 1 h to 50 h, from 1 h to 100 h, from 1 h to 168 h, from 10 h to 20 h, from 10 h to 30 h, from 10 h to 50 h, from 10 h to 100 h, from 10 h to 168 h, from 20 h to 30 h, from 20 h to 50 h, from 20 h to 100 h, from 20 h to 168 h, from 30 h to 50 h, from 30 h to 100 h, from 30 h to 168 h, from 50 h to 100 h, from 50 h to 168 h, or from 100 h to 168 h. In some embodiments, an in-situ rejuvenation can be performed while the energy device is not being used (e.g., when a vehicle is not being charged or driven). In some embodiments, an in-situ rejuvenation can be performed while the energy device is being charged.

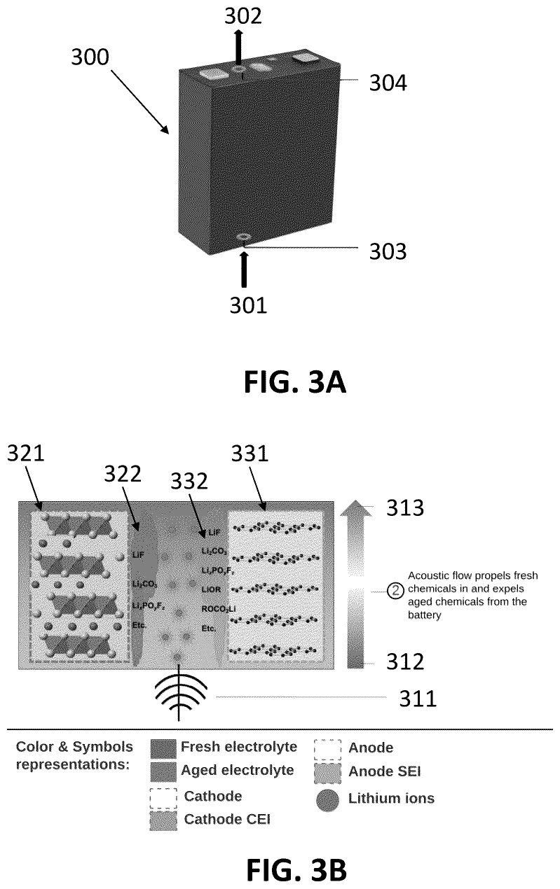

FIG. 3A shows an exemplary energy device comprising a cell. The cell 300 can comprise one or more inlets (e.g., 301) for supplying fresh chemicals (e.g., fresh electrolytes) into the cell. The cell can comprise one or more outlets (e.g., 302) for directing the aged chemicals (e.g., aged electrolytes) out of the cell. The cell can comprise one or more resealable openings or points (e.g., 303) for sealing the inlets. The cell can comprise one or more resealable openings or points (e.g., 304) for sealing the outlets. In some embodiments, an acoustic device (e.g., a SAW device) can be coupled to the energy device. In some embodiments, the acoustic device can enable an exchange of an aged electrolyte with a fresh electrolyte, as illustrated in FIG. 3B. Fresh electrolyte can be flown in through an inlet, and used/aged electrolyte can be expelled out of the energy device through an outlet. The arrow shows the direction of the electrolyte flow. In some embodiments, the electrolyte can flow in a different direction. The tail of the arrow shows the fresh electrolyte flown in (312), and the head of the arrow shows the aged/used electrolyte flown out (313). An acoustic device can be coupled to the energy device to provide acoustic waves (311). In some embodiments, the used/aged energy device may have reduced or depleted ions in the electrodes (e.g., cathode 321 and/or anode 331) and/or interphase layers (e.g., cathode CEI layer 322 and/or anode SEI layer 332). In some embodiments, the used/aged energy device may have thicker interphase layers. In some embodiments, the used/aged energy device may have a degraded electrolyte. In some embodiments, the used/aged energy device may have lower ion concentrations. After the rejuvenation, the energy device can be replenished with fresh electrolyte, the thickness of the interphase layers can be reduced, and the ions in the electrodes and interphase layers can be replenished. Although FIG. 3A shows a cell with an inlet and an outlet, as disclosed above, a cell can have openings that serve as both an inlet and an outlet (e.g., the fresh electrolyte and the aged electrolyte can flow through the same opening). In some embodiments, the cell may not have an opening, and the acoustic device can rejuvenate the cell in situ.

In some embodiments, rejuvenating the energy device can comprise restoring the capacity of the energy device to a desired capacity. In some embodiments, rejuvenating the energy device can comprise increasing a capacity of the energy device by at least about 1%, at least about 5%, at least about 10%, at least about 20%, at least about 30%, at least about 40%, at least about 50%, at least about 60%, at least about 70%, at least about 80%, at least about 90%, or more.

In some embodiments, rejuvenating the energy device can increase a capacity of the energy device by at least about 1%, at least about 5%, at least about 10%, at least about 20%, at least about 30%, at least about 40%, at least about 50%, at least about 60%, at least about 70%, at least about 80%, at least about 90%, or more.

In some embodiments, rejuvenating the energy device can comprise restoring a capacity of the energy device to at least about 60%, at least about 70%, at least about 80%, at least about 85%, at least about 90%, at least about 95%, at least about 97%, at least about 99%, or more of an original capacity of the energy device.

In some embodiments, the energy device can have less than about 90%, less than about 85%, less than about 80%, less than about 75%, less than about 70%, less than about 65%, or less than about 60% of its original capacity prior to rejuvenation.

In some embodiments, the energy device can have greater than about 60%, greater than about 65%, greater than about 70%, greater than about 75%, greater than about 80%, greater than about 85%, greater than about 90%, greater than about 95%, or more of its original capacity after rejuvenation.

In some embodiments, the energy device rejuvenated with an acoustic device can have a higher capacity as compared to when the acoustic device is not used. In some embodiments, the capacity can be improved by at least about 1%, at least about 2%, at least about 5%, at least about 10%, at least about 20%, at least about 30%, at least about 40%, at least about 50%, at least about 60%, at least about 70%, at least about 80%, at least about 90%, at least about 95%, or more, as compared to when the acoustic device is not used.

In some embodiments, the fresh or unused chemicals can comprise a fresh or unused electrolyte. In some embodiments, the aged or used chemicals can comprise a used electrolyte. A used electrolyte may have a reduced volume in comparison to the fresh electrolyte in the energy device. In some embodiments, the reduced volume may be at least about 1%, at least about 5%, at least about 10%, at least about 20%, at least about 30%, at least about 40%, at least about 50%, or more. A used electrolyte may have an increased viscosity in comparison to the fresh electrolyte in the energy device. In some embodiments, the increased viscosity may be at least about 1%, at least about 5%, at least about 10%, at least about 20%, at least about 30%, at least about 40%, at least about 50%, or more. A used electrolyte may have a reduced concentration of an ion. In some embodiments, the reduced concentration may be at least about 1%, at least about 5%, at least about 10%, at least about 20%, at least about 30%, at least about 40%, at least about 50%, or more. A used electrolyte may have a reduced ionic conductivity. In some embodiments, the reduced ionic conductivity may be at least about 1%, at least about 5%, at least about 10%, at least about 20%, at least about 30%, at least about 40%, at least about 50%, or more.

In some embodiments, the aged or used chemicals can be in a semi-solid, gel, or liquid form factors. In some embodiments, the fresh or unused chemicals can be provided in a semi-solid, gel, or a liquid form factor.

In some embodiments, the thickness of an interphase layer can increase during the usage of the energy device. In some embodiments, the interphase layer can comprise a solid electrolyte interphase (SEI). In some embodiments, the interphase layer can comprise a cathode electrolyte interphase (CEI). In some embodiments, the interphase layer can comprise an anode electrolyte interphase. In some embodiments, the thickness of the interphase layer of a used energy device can be at least about 5%, at least about 10%, at least about 20%, at least about 30%, at least about 50%, at least about 60%, at least about 70%, at least about 80%, at least about 90%, or more, thicker than a new or fresh energy device. In some embodiments, the thick interphase layer can increase cell impedance and/or impede ion diffusion.

In some embodiments, the acoustic waves generated from the at least one acoustic device can be streamed to the energy device to enhance the interaction between the interphase layer and the electrolyte (e.g., in in-situ rejuvenation) and/or the fresh electrolyte. In some embodiments, the acoustic waves (e.g., specifically tuned acoustic waves) can create microscale or nanoscale acoustofluidics in a mobile species of the energy device (e.g., micro-stirring effect). The micro-stirring effect by the acoustic waves can enhance the mobility and movement of the mobile species (e.g., cations and/or anions) of the electrolyte during the rejuvenation. The enhanced mobilization and movement of mobile species can lead to better distribution of the mobile species within the energy device. In some embodiments, the acoustic waves can induce turbulent flow in the electrolyte. In some embodiments, the acoustic waves can generate accelerations of the mobile species from about 10⁸ m/s² to about 10¹⁰ m/s². In some embodiments, the acoustic waves can induce a fluid flow rate up to about 1 m/s. In some embodiments, the accelerations of the mobile species or the flow of the mobile species may generate a shear force on the SEI or CEI to destroy a portion of the interphase layers. In some embodiments, the mobile species can move to the vicinity of the electrodes and/or the separator more readily. In some embodiments, mobile species, e.g., cations and anions, can be evenly available throughout the cell. In some embodiments, the acoustic wave can modulate the ionic concentration gradient for a more uniform distribution of the mobile species.

In some embodiments, the interaction between the interphase layer and the fresh electrolyte can wash away at least a portion of the interphase layer. In some embodiments, the electrolyte may dissolve at least a portion of the interphase layers. In some embodiments, the interaction between the interphase layer and the fresh electrolyte can reduce the amount, thickness, or non-uniformity of one or more interphase layers within the energy device. In some embodiments, the amount or thickness of the interphase layer can be reduced by at least about 1%, at least about 5%, at least about 10%, at least about 20%, at least about 30%, at least about 40%, at least about 50%, at least about 60%, or more.

In some embodiments, rejuvenating the energy device can comprise forming homogenous or uniform stable interphase layers within the energy device.

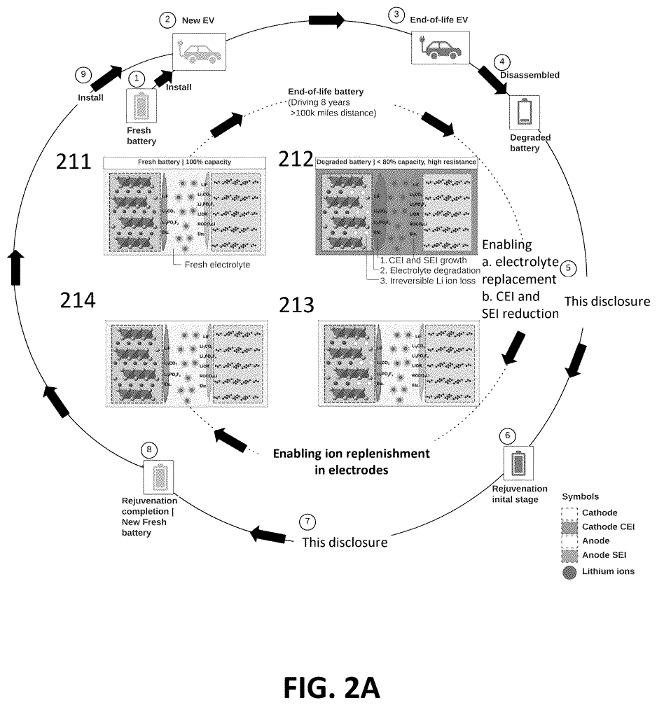

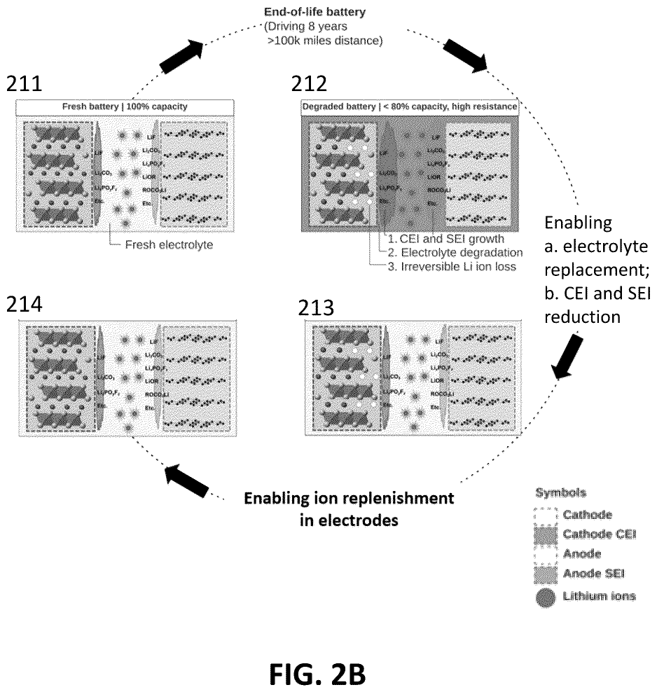

FIGS. 2A and 2B show exemplary states of the energy device. 211 shows an exemplary fresh energy device comprising a cell (e.g., a battery cell). The fresh cell can have a 100% capacity with thin CEI and SEI layers and fresh electrolyte. 212 shows an exemplary aged cell with reduced capacity (e.g., less than about 80%). In the aged cell 212, the CEI and SEI layers may be thicker than those in the fresh cell 211. The electrolyte in the aged cell 212 may have been degraded. The aged cell may have irreversible ion loss. The aged cell may have high resistance. 213 shows an exemplary rejuvenated cell. In some embodiments, through the rejuvenation process, at least a portion of the used electrolyte can be replaced with fresh electrolyte. Acoustic waves can be streamed to the cell during the rejuvenation.

In some embodiments, through the rejuvenation process, the thickness of the CEI and SEI layers can be reduced. In some embodiments, through the rejuvenation process, the capacity of the used cell (e.g., capacity less than about 80%) can be increased by at least about 5%, at least about 10%, at least about 15%, at least about 20%, at least about 30%, at least about 40%, at least about 50%, at least about 60%, at least about 70%, at least about 80%, at least about 90%, or more. In some embodiments, through the rejuvenation process, the ions (e.g., lithium ions of a lithium battery or an ion of the corresponding battery) of the cathode can be replenished. In some embodiments, through the rejuvenation process, the ion concentration of the cathode can be increased by at least about 5%, at least about 10%, at least about 15%, at least about 20%, at least about 30%, at least about 40%, at least about 50%, at least about 60%, at least about 70%, at least about 80%, at least about 90%, or more. In some embodiments, through the rejuvenation process, the capacity of the energy device can be increased to at least about 85%, at least about 90%, at least about 95%, at least about 97%, at least about 99%, or more of the original energy device (or fresh energy device before use). 214 shows an exemplary rejuvenated cell (e.g., capacity greater than about 97%) with reduced CEI and SEI layers and replenished ions in the electrolyte and electrodes.

FIG. 2A also shows an exemplary life cycle of an energy device (e.g., a battery) with rejuvenation. A fresh battery 1 is installed in a vehicle, e.g., a new electric vehicle (EV) 2. At the end of the life of the EV (3 in FIG. 2A), e.g., after driving more than 8 years or more than 100 k miles, the EV can be disassembled (4 in FIG. 2A). The degraded battery may have less than about 80% or lower capacity and high resistance. Through the system and method disclosed in the present disclosure, the degraded battery can be rejuvenated. Process 6 of FIG. 2A shows a rejuvenation initial stage, in which the degraded battery can be replenished with fresh electrolyte. The fresh electrolyte can replace the aged electrolyte in the battery and reduce the CEI and SEI layers (e.g., the thickness or density). Process 7 of FIG. 2A shows a further rejuvenation process to further rejuvenate the battery, in which the ions in the electrodes can be replenished. The further rejuvenation in process 7 of FIG. 2A can further increase the capacity of the battery. At process 8 of FIG. 2A, the rejuvenation completes, and a new fresh battery is obtained. The new fresh battery can have more than about 97% capacity of the fresh battery 1. The new fresh battery can be installed (process 9 of FIG. 2A) to an EV.

In some embodiments, a bulk impedance of the energy device can be reduced by at least about 10%, at least about 15%, at least about 20%, at least about 30%, at least about 40%, at least about 50%, at least about 60%, at least about 70%, at least about 80%, or more after the rejuvenation. In some embodiments, the energy device rejuvenated with an acoustic device can have a lower bulk impedance as compared to when the acoustic device is not used. In some embodiments, the bulk impedance can be reduced by at least about 1%, at least about 2%, at least about 5%, at least about 10%, at least about 20%, at least about 30%, at least about 40%, at least about 50%, at least about 60%, at least about 70%, at least about 80%, at least about 90%, at least about 95%, or more, as compared to when the acoustic device is not used.

In some embodiments, an interphase impedance of the energy device can be reduced by at least about 10%, at least about 15%, at least about 20%, at least about 30%, at least about 40%, at least about 50%, at least about 60%, at least about 70%, at least about 80%, or more after the rejuvenation. In some embodiments, the energy device rejuvenated with an acoustic device can have a lower interphase impedance as compared to when the acoustic device is not used. In some embodiments, the interphase impedance can be reduced by at least about 1%, at least about 2%, at least about 5%, at least about 10%, at least about 20%, at least about 30%, at least about 40%, at least about 50%, at least about 60%, at least about 70%, at least about 80%, at least about 90%, at least about 95%, or more, as compared to when the acoustic device is not used.

In some embodiments, the acoustic waves can facilitate or increase mass transport of the mobile species within the energy device. In some embodiments, the mass transport rate of mobile species in the energy device can be increased by at least about 1%, at least about 2%, at least about 5%, at least about 10%, at least about 15%, at least about 20%, at least about 30%, at least about 40%, at least about 50%, at least about 60%, at least about 70%, at least about 80%, at least about 90%, at least about 100%, or more after the rejuvenation. In some embodiments, the energy device rejuvenated with an acoustic device can have a higher mass transport rate as compared to when the acoustic device is not used. In some embodiments, the mass transport rate can be increased by at least about 1%, at least about 2%, at least about 5%, at least about 10%, at least about 20%, at least about 30%, at least about 40%, at least about 50%, at least about 60%, at least about 70%, at least about 80%, at least about 90%, at least about 95%, or more, as compared to when the acoustic device is not used.

In some embodiments, the initial coulombic efficiency (ICE) of the energy device can be improved by at least about 10%, at least about 20%, at least about 30%, at least about 40%, at least about 50%, at least about 60%, at least about 70%, at least about 80%, at least about 90%, at least about 100%, or more after the rejuvenation. In some embodiments, the energy device rejuvenated with an acoustic device can have a higher ICE as compared to when the acoustic device is not used. In some embodiments, the ICE can be increased by at least about 1%, at least about 2%, at least about 5%, at least about 10%, at least about 20%, at least about 30%, at least about 40%, at least about 50%, at least about 60%, at least about 70%, at least about 80%, at least about 90%, at least about 95%, or more, as compared to when the acoustic device is not used.

In some embodiments, an output discharge voltage of the energy device can be at least about 10%, at least about 20%, at least about 30%, at least about 40%, at least about 50%, at least about 60%, at least about 70%, at least about 80%, at least about 90%, at least about 100%, or more, higher after the rejuvenation. In some embodiments, the energy device rejuvenated with an acoustic device can have a higher output discharge voltage as compared to when the acoustic device is not used. In some embodiments, the output discharge voltage can be increased by at least about 1%, at least about 2%, at least about 5%, at least about 10%, at least about 20%, at least about 30%, at least about 40%, at least about 50%, at least about 60%, at least about 70%, at least about 80%, at least about 90%, at least about 95%, or more, as compared to when the acoustic device is not used.

In some embodiments, an output energy efficiency of the energy device can be at least about 10%, at least about 20%, at least about 30%, at least about 40%, at least about 50%, at least about 60%, at least about 70%, at least about 80%, at least about 90%, at least about 100%, or more, higher after the rejuvenation. In some embodiments, the energy device rejuvenated with an acoustic device can have a higher output energy efficiency as compared to when the acoustic device is not used. In some embodiments, the output energy efficiency can be increased by at least about 1%, at least about 2%, at least about 5%, at least about 10%, at least about 20%, at least about 30%, at least about 40%, at least about 50%, at least about 60%, at least about 70%, at least about 80%, at least about 90%, at least about 95%, or more, as compared to when the acoustic device is not used.

In some embodiments, an energy density delivered during discharge of the energy device can be at least about 10%, at least about 20%, at least about 30%, at least about 40%, at least about 50%, at least about 60%, at least about 70%, at least about 80%, at least about 90%, at least about 100%, or more, higher after the rejuvenation. In some embodiments, the energy device rejuvenated with an acoustic device can have a higher energy density delivered during discharge as compared to when the acoustic device is not used. In some embodiments, the energy density delivered during discharge can be increased by at least about 1%, at least about 2%, at least about 5%, at least about 10%, at least about 20%, at least about 30%, at least about 40%, at least about 50%, at least about 60%, at least about 70%, at least about 80%, at least about 90%, at least about 95%, or more, as compared to when the acoustic device is not used.

In some embodiments, a long-term cycling stability of the energy device can be improved by at least about 10%, at least about 20%, at least about 30%, at least about 40%, at least about 50%, at least about 60%, at least about 70%, at least about 80%, at least about 90%, at least about 100%, or more, after the rejuvenation. In some embodiments, the energy device rejuvenated with an acoustic device can have a higher long-term cycling stability as compared to when the acoustic device is not used. In some embodiments, the long-term cycling stability can be increased by at least about 1%, at least about 2%, at least about 5%, at least about 10%, at least about 20%, at least about 30%, at least about 40%, at least about 50%, at least about 60%, at least about 70%, at least about 80%, at least about 90%, at least about 95%, or more, as compared to when the acoustic device is not used.

In some embodiments, the energy device can be rejuvenated while being agnostic to an electrochemical cell chemistry and/or geometry of the energy device.

In some embodiments, the method can further comprise using the at least one acoustic device to generate and stream the acoustic waves to replenish ions (e.g., Li⁺, Na⁺) to an electrode (e.g., cathode or anode) of the energy device to restore an ionic concentration within the energy device. In some embodiments, replenishing ions to the electrodes can further increase the capacity of the energy device. In some embodiments, the ions can be replenished to the electrode (e.g., cathode or anode) of the energy device via intercalation, conversion, alloying, or plating.

In some embodiments, the energy device can be rejuvenated without requiring the disassembly of the energy device. In some embodiments, the energy device can be rejuvenated without disassembly of the energy device. In some embodiments, a plurality of acoustic devices can be operatively coupled to the energy device (e.g., comprising a plurality of cells). In some embodiments, a fresh electrolyte source (e.g., an electrolyte reservoir) can be connected to the cells of the energy device for supplying the fresh electrolyte. In some embodiments, the energy device can be connected to a plurality of fresh electrolyte sources. In some embodiments, a solvent source (e.g., a solvent reservoir) can be connected to the cells of the energy device for supplying the solvent. In some embodiments, at least a portion of the used electrolyte can be replaced directly with fresh electrolyte. In some embodiments, at least a portion of the used electrolyte can be washed out or expelled by the solvent, and then fresh electrolyte can be flown into the cells. In some embodiments, the rejuvenation can comprise expelling at least a portion of the used electrolyte in the energy device by a solvent and replenishing fresh electrolyte to the energy device. In some embodiments, the rejuvenation can comprise expelling at least a portion of the used electrolyte in the energy device by the fresh electrolyte. In some embodiments, the solvents can comprise a polar solvent, such as isopropanol, ethyl acetate, dimethyl carbonate, ethylene carbonate, dimethyl sulfoxide, tetrahydrofuran, acetonitrile, diethyl carbonate, dimethoxyethane, or a combination thereof, in some embodiments, the solvents can comprise a nonpolar solvent, such as toluene, hexane, pentane, or a combination thereof. In some embodiments, the solvent can comprise a mixture of any of the polar solvents and any of the non-polar solvents. In some embodiments, the solvent can be removed by using a vacuum or electrolytes. In some embodiments, the solvent or the electrolyte can dissolve at least a portion of the SEI and/or CEI layers. In some embodiments, the rejuvenation can be performed with a lithiation agent. In some embodiments, the lithiation agent can replenish the used electrolyte and/or the electrodes with lithium ions. In some embodiments, the rejuvenation is performed in situ as disclosed in the present disclosure, wherein no new electrolyte is introduced to the energy device, and no aged electrolyte is expelled from the energy device.

In some embodiments, the method may comprise re-lithiation of the electrolyte and/or electrode. In some embodiments, the re-lithiation may comprise a chemical lithiation or electrochemical lithiation. In some embodiments, the re-lithiation may be performed for 0.1 h to 5 h. In some embodiments, the re-lithiation may be performed for less than 2 h.

In some embodiments, the chemical lithiation may comprise introducing a solution of lithiated redox-active organic molecules into the cell for lithium replenishment. In some embodiments, the lithiated redox active organic molecules may have an electrochemical potential lower than the cathode to avoid decomposition. In some embodiments, the lithiated redox active organic molecules may have high solubility for efficient reaction. In some embodiments, the lithiated redox active organic molecules may have a fast reaction rate. In some embodiments, the lithiated redox active organic molecules can comprise 2-phenyl-1,4-naphthoquinone, quinoxaline, perylene, pyrene, N-methylphthalimide, or a combination thereof. After the lithiation, the method can comprise washing out or expelling the aged electrolyte and residual redox-active organic molecules. During the washing out or lithium replenishment, the thickness of SEI and/or CEI may be reduced, and lithium ions may diffuse into the electrodes. After the washing out, the method can comprise injecting or introducing fresh electrolyte.

In some embodiments, the electrochemical lithiation may comprise removing aged electrolyte, e.g., by solvent washing or electrolyte washing. During the washing, the thickness of SEI and/or CEI may be reduced. After the removal, the method can comprise injecting or introducing fresh electrolyte. The method may further comprise discharging the cathode against a lithium source to replenish lithium. In some embodiments, the lithium source can comprise a lithium anode. The electrochemical lithiation may avoid introducing other reagents and eliminate the need to rinse the cell before refilling the electrolyte. In some embodiments, acoustic waves may be applied during the lithiation process.

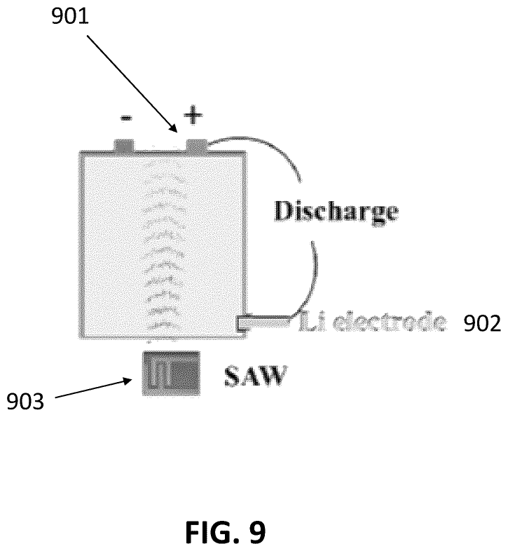

FIG. 9 shows an exemplary setup for electrochemical lithiation. It comprises applying a potential between the cathode 901 and an additional lithium-containing electrode 902. The setup facilitates the transfer of lithium ions from the additional lithium-containing electrode to the cathode, replenishing the lost lithium in the cathode. During the lithiation, a SAW device 903 may be coupled to the energy device to apply acoustic waves to the energy device. The SAW may increase the convection of the ions.

In some embodiments, the rejuvenation can take a duration from about 0.1 h to about 0.5 h, from about 0.1 h to about 1 h, from about 0.1 h to about 10 h, from about 0.1 h to about 100 h, from about 0.1 h to about 168 h, from about 0.2 h to about 1 h, from about 0.2 h to about 10 h, from about 0.2 h to about 100 h, from about 0.2 h to about 168 h, from about 0.5 h to about 1 h, from about 0.5 h to about 10 h, from about 0.5 h to about 100 h, from about 0.5 h to about 168 h, from about 1 h to about 10 h, from about 1 h to about 100 h, from about 1 h to about 168 h, about 10 h to about 100 h, from about 10 h to about 168 h, or from about 100 h to about 168 h. In some embodiments, using an acoustic device in the rejuvenation can reduce the time needed for the rejuvenation. In some embodiments, the time can be reduced by at least about 5%, at least about 10%, at least about 20%, at least about 30%, at least about 40%, at least about 50%, or more, in comparison to the rejuvenation without applying acoustic waves.

In some embodiments, the sensor or detector can monitor the one or more parameters (e.g., a capacity, a bulk impedance, an interphase impedance, or a thickness of interphase layers) and/or a variance thereof of the energy device during and/or after a rejuvenation process. In some embodiments, the acoustic waves can interact with the energy device (e.g., electrodes) and generate a feedback signal. In some embodiments, the method can comprise measuring the thickness of the interphase layers. In some embodiments, the sensor or detector can generate a signal indicative of one or more parameters of the energy device. In some embodiments, the sensor or detector can send a signal to the acoustic device. In some embodiments, the feedback signal can be detected by a standalone sensor or detector. In some embodiments, based on the feedback signal, the acoustic device can modify one or more parameters of the acoustic waves (e.g., power, frequency, etc.) and/or operation parameters (e.g., temperature, duration, etc.).

In some embodiments, the method can comprise determining the capacity of the energy device. In some embodiments, the method can comprise determining a volume of the electrolyte in the energy device. In some embodiments, the method can comprise determining a composition of the electrolyte in the energy device. In some embodiments, the method can comprise determining a property (e.g., viscosity, ion concentration) of the electrolyte in the energy device. In some embodiments, any of the determinations disclosed herein can be performed before the rejuvenation so the parameters can be used as a basis for the determination of the rejuvenation process, e.g., electrolyte needed, time needed for the rejuvenation, acoustic wave properties, etc. In some embodiments, any of the determinations disclosed herein can be performed during the rejuvenating to monitor the rejuvenating process. In some embodiments, any of the determinations disclosed herein can be performed after the rejuvenation to verify the completeness and efficiency of the rejuvenation.

### Energy Device

In some embodiments, the energy device can comprise one or more electrochemical cells. In some embodiments, the energy device can comprise at least one, at least two, at least three, at least four, at least five, at least six, at least seven, at least eight, at least nine, at least ten, at least 20, at least 30, at least 40, at least 50, at least 60, at least 70, at least 80, at least 90, at least 100, at least 200, at least 500, at least 1000, or more electrochemical cells. In some embodiments, the one or more electrochemical cells can comprise one or more different cell chemistries.

In some embodiments, the energy device of the present disclosure can comprise a liquid electrolyte battery. In some embodiments, the energy device of the present disclosure can comprise a solid-state or semi-solid-state battery, a fuel cell, an electrolyzer, a capacitor, a supercapacitor, a flow battery, or a metal-air battery.

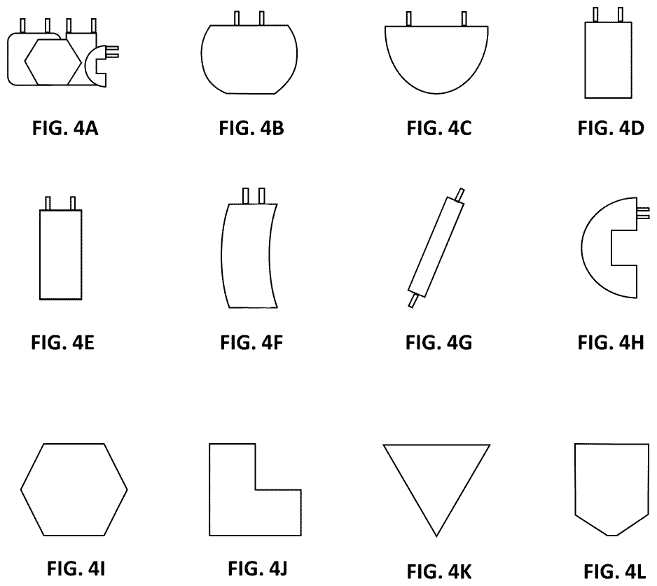

In some embodiments, the energy device can have form factors comprising coin cells, pouch cells, cylindrical cells, or prismatic cells. In some embodiments, the energy device can be regularly shaped. In some embodiments, the energy device can comprise an irregular shape or a customed shape. In some embodiments, the irregular shape can be a polygonal shaped cell (e.g., FIG. 4L), which can include triangular shaped cells (e.g., FIG. 4K), rectangular cells (e.g., FIG. 4D, 4E), pentagonal cells, hexagonal cells (e.g., FIG. 4I), and the like. Irregularly-shaped cells can include L-shaped cells (e.g., FIG. 4J), curved cells (e.g., FIG. 4F), round Lipo cells (e.g., FIG. 4C), or C-shaped cells (e.g., FIG. 4H). Other irregularly-shaped cells can include ultranarrow cells (e.g., FIG. 4G), ultrathin cells (e.g., FIG. 4E), D-shaped cells (e.g., FIG. 4B), and the like. In some embodiments, the energy device can comprise a plurality of cells with different shapes (e.g., FIG. 4A).

In some embodiments, an energy device can have a capacity ranging from 1 μWh to 1 MWh. In some embodiments, the energy device can have a capacity ranging from about 1 μWh to about 1 MWh, about 5 μWh to about 1 MWh, from about 10 μWh to about 500 kWh, from about 20 ρWh to about 250 kWh, from about 50 ρWh to about 100 kWh, from about 100 μWh to about 75 kWh, from about 250 μWh to about 50 kWh, from about 500 μWh to about 25 kWh, from about 750 μWh to about 10 kWh, from about 1 mWh to about 1 kWh, from about 25 mWh to about 750 Wh, from about 50 mWh to about 500 Wh, from about 75 mWh to about 250 Wh, from about 100 mWh to about 100 Wh, about 200 mWh to about 75 Wh, from about 500 mWh to about 50 Wh, or from about 1000 mWh to about 25 Wh or from about 5000 mWh to about 1 Wh. In some embodiments, the energy device can have a capacity of at least about 50 mWh, at least about 100 mWh, at least about 250 mWh, at least about 500 mWh, at least about 1000 mWh, at least about 2000 mWh, at least about 5000 mWh, at least about 7500 mWh, at least about 1 Wh, at least about 2 Wh, at least about 5 Wh, at least about 10 Wh, at least about 25 Wh, at least about 50 Wh, at least about 100 Wh, at least about 1 kWh, at least about 5 kWh, at least about 10 kWh, at least about 100 kWh, at least about 500 kWh, at least about 1 MWh, or more. In some embodiments, the energy device can have a capacity of at most about 1 MWh, at most about 500 kWh, at most about 250 kWh, at most about 100 kWh, at most about 75 kWh, at most about 50 kWh, at most about 25 kWh, at most about 10 kWh, at most about 1 kWh, at most about 500 Wh, at most about 250 Wh, at most about 100 Wh, at most about 50 Wh, at most about 25 Wh, at most about 10 Wh, at most about 5 Wh, or at most about 1 Wh.

In some embodiments, the energy device can be any type of battery including, for example, a lithium (Li) battery, a sodium (Na) battery, a potassium (K) battery, a copper (Cu) battery, a zinc (Zn) battery, a magnesium (Mg) battery, or a lithium ion battery. In some embodiments, the one or more electrochemical cells can comprise a lithium-ion battery and/or a lithium metal battery. In some embodiments, the one or more electrochemical cells can comprise a sodium-ion battery and/or a sodium metal battery. In some embodiments, the one or more electrochemical cells comprise a lead-acid battery.

In some embodiments, the energy device can comprise at least two electrodes. In some embodiments, the energy device can comprise an anode and a cathode. In some embodiments, the anode and the cathode can be separated by an ionically conductive bridge.

In some embodiments, the cathode can comprise Li. In some embodiments, the cathode can comprise a material selected from the group consisting of LifePO₄; LiFeₓMn_{y}PO₄, wherein x+y=1; LiMn₂O₄; LiNi_{0.5}Mn_{1.5}O₄; LiNiₓCo_{y}Mn₂O₂, wherein x+y+z=1; LiCoO₂; LiNiₓCo_{y}Al₂O₂, wherein x+y+z=1; and aLiNiₓCo_{y}Mn₂O₂·(1−a)Li₂MnO₃, wherein a is from 0 to 1 and x+y+z=1. In some embodiments, the cathode is Li-free. In some embodiments, the cathode can comprise a material selected from the group of oxides, fluorides, oxyfluorides, sulfur-based materials, and gases.

In some embodiments, the cathode can be lithium containing intercalation chemistry-based or intercalation type-layered (e.g., involving transition metal oxides, transition metal phosphate, vanadium oxides, molybdenum oxides) for Li ion battery or Li metal battery. In some embodiments, the cathode can be sodium containing intercalation chemistry-based or intercalation type-layered (e.g., involving transition metal oxides, transition metal phosphate, iron hexacyanoferrate (prussian blue, prussian white), vanadium oxides, molybdenum oxides) for Na ion battery or Na metal battery. In some embodiments, the cathode can be potassium containing intercalation chemistry-based or intercalation type-layered (e.g., involving transition metal oxides, transition metal phosphate, iron hexacyanoferrate (prussian blue, prussian white), vanadium oxides, molybdenum oxides) for K ion battery or K metal battery.

In some embodiments, the cathode can comprise a layered lithium intercalated transition metal oxides, lithium intercalated transition metal oxides, lithium intercalated phosphate, pre-lithiated sulfur, pre-lithiated multivalent metal fluorides, pre-lithiated multivalent metal sulfides, or pre-lithiated multivalent metal oxides. In some embodiments, the cathode can comprise a layered sodium intercalated transition metal oxide, sodium intercalated transition metal oxide, sodium intercalated phosphate, sodium intercalated iron hexacyanoferrate (prussian blue, prussian white), pre-sodiated sulfur, pre-sodiated multivalent metal fluorides, pre-sodiated multivalent metal sulfides, or pre-sodiated multivalent metal oxides. In some embodiments, the cathode can comprise a layered potassium intercalated transition metal oxide, potassium intercalated transition metal oxide, potassium intercalated phosphate, potassium intercalated iron hexacyanoferrate (prussian blue, prussian white), pre-potassiated sulfur, pre-potassiated multivalent metal fluorides, pre-potassiated multivalent metal sulfides, or pre-potassiated multivalent metal oxides.

In some instances, the anode can be made of an anode material capable of catalyzing a chemical reaction. In some embodiments, the anode can comprise an anode material, such as graphite, graphene, Al, Cu, Si, Sn, SiOₓ, SnOₓ, P, lithium titanium oxide (LTO), hard carbon, soft carbon, or a combination thereof.

In some embodiments, the anode can be a Li-containing material. In some embodiments, the Li-containing material can be Li metal foil, Li metal on Cu foil, Li metal on carbon substrate, Li metal on porous metal substrate, or Li metal on porous carbon substrate. In some embodiments, the anode can comprise one or more of the following materials: graphite, Li₄Ti₅O₁₂, Si, Sn, P, hard carbon, soft carbon, Al, or combinations thereof, for use in a Li-ion battery. In some embodiments, the anode can comprise one or more of the following materials: Sn, P, hard carbon, soft carbon, or combinations thereof, for use in a Na-ion battery. In some embodiments, the anode can comprise one or more of the following materials: graphite, Sn, P, hard carbon, soft carbon, or combinations thereof, for use in a K-ion battery.

In some embodiments, the energy device can comprise an electrolyte. In some embodiments, the electrolyte can be a nonaqueous electrolyte or an aqueous electrolyte (e.g., a water-in-salt electrolyte). In some embodiments, the electrolyte can comprise a liquid electrolyte, a semi-solid electrolyte, a liquified gas electrolyte, or a polymer or polymer gel electrolyte.

In some embodiments, the electrolyte can be made of a material that enables ions (e.g., cations) and/or electrons transport between the electrodes of the energy device. When the energy device is coupled with the acoustic device of the present disclosure, the electrolyte can be perturbed by the generated acoustic waves. In some embodiments, the electrolyte material can be a porous material, such that cations or charge carriers can diffuse through the electrolyte. In some embodiments, the electrolyte material can be a porous material with an average pore diameter suitable for Li ion diffusion. In some embodiments, the electrolyte can comprise a salt. In some embodiments, the salt can comprise a lithium salt. In some embodiments, the electrolyte can comprise lithium salt containing water, carbonate solvents, ether solvents, ionic liquids, sulfone-based solvents, or phosphate-based solvents. In some embodiments, the lithium salt can comprise lithium carbonate, lithium sulfate, lithium perchlorate, lithium phosphate, lithium fluorophosphate, lithium nitrate, or a combination thereof. In some embodiments, the lithium salt can comprise LiPF₆, LiFSI, LiSO₄, LiClO₃, LIDFOB, LiBF₄, or LiNO₃. In some embodiments, the electrolyte may be present at a concentration from about 10 mM to about 30 M. In some embodiments, the electrolyte may be present at a concentration of about 100 mM, about 1 M, about 2 M, about 3 M, about 4 M, about 5 M, about 6 M, about 7 M, about 8 M, about 9 M, about 10 M, about 15 M, or about 20 M.

In some embodiments, the electrolyte material can comprise an aqueous electrolyte, such as an ionic liquid. In some embodiments, the ionic liquid can comprise a quaternary amine, such as imidazolium, NH₄⁺, pyrrolidinium, or piperidinium. In some embodiments, a nonaqueous electrolyte may be present. In some embodiments, the nonaqueous electrolyte may comprise a carbonate, an ether, a phosphate, a sulfone, an ionic liquid, an amide, a ketone, an ester, an alcohol, an aromatic, or the like. In some embodiments, the carbonate may comprise ethylene carbonate (EC), ethylmethyl carbonate (EMC), propylene carbonate (PC), dimethyl carbonate (DMC), or the like. In some embodiments, the ether may comprise diethyl ether (DEE), fluoroethylene carbonate (FEC), tetrahydrofuran (THF), dioxolane (DIOX), or the like. In some instances, the phosphate may comprise trimethyl phosphate (TMP), triethyl phosphate (TEP), triphenyl phosphate (TPP), or the like. In some embodiments, the sulfone may comprise sulfolane, 1,3-propane sulfone, or the like. In some embodiments, the ionic liquid may comprise an imidazolium-based salt, a pyridinium-based salt, or the like. In some embodiments, the amide may comprise N,N-dimethylformamide (DMF), N-methylacetamide (NMA), or the like. In some embodiments, the ketone may be acetone, 2,3-butanedione, or the like. In some embodiments, the ester may be ethyl acetate, butyl acetate, or the like. In some embodiments, the alcohol may be methanol, ethanol, propanol, isopropanol, butanol, or the like. In some embodiments, the nonaqueous electrolyte may comprise an aromatic solvent, such as toluene, xylene, or the like. In some embodiments, the electrolyte material can comprise an electrolyte composition comprising at least two electrolytes. In some embodiments, a first electrolyte and a second electrolyte of the at least two electrolytes may be present in a ratio. In some embodiments, the ratio can be from about 1:100 to about 100:1. In some embodiments, the ratio can be about 1:100, about 1:50, about 1:25, about 1:20, about 1:10, about 1:9, about 1:8, about 1:7, about 1:6, about 1:5, about 1:4, about 1:3, about, 1:2, about 1:1, about 2:3, about 2:5, about 2:7, about 2:9, about 3:5, about 3:7, about 3:8, about 4:5, about 4:7, about 4:9, or about 5:7. In some embodiments, the electrolyte composition can comprise ethylene carbonate (EC) and ethylmethyl carbonate (EMC). In some embodiments, the ratio of EC to EMC can be about 1:1, about 1:2, about 1:3, about 1:4, about 1:5, about 2:3, about 2:5, about 3:5, or about 3:7.

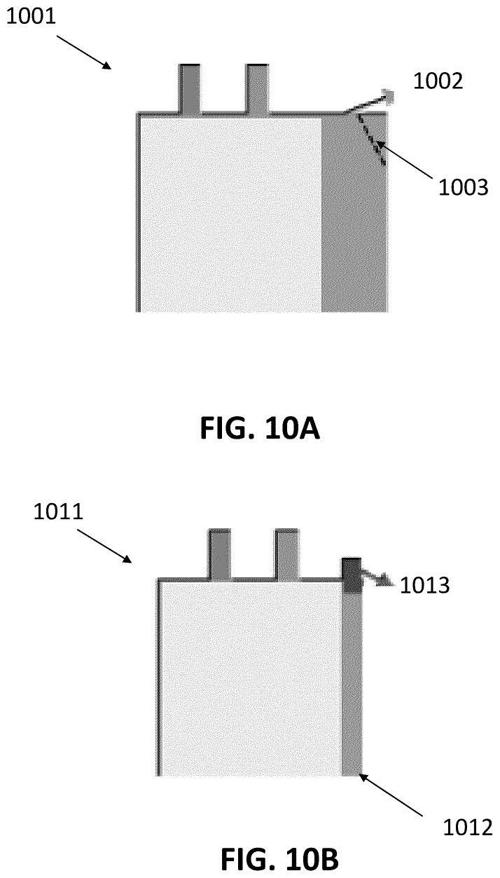

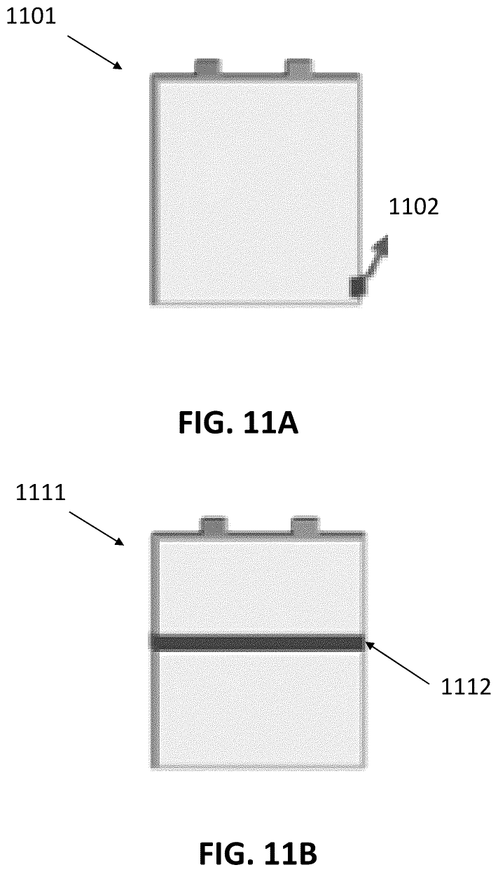

In some embodiments, the cells of the energy device may comprise a resealable casing. FIG. 10A shows an exemplary pouch cell 1001 with an extra sealing bag area 1002. The extra sealing bag area allows cutting the edge (e.g., 1003) of the pouch cell to open the cell for injecting solvent or electrolyte and/or expelling aged electrolyte. The pouch cell can be sealed after the rejuvenation process. The extra sealing bag may comprise a layer of polyamide, polyester-polyurethane, aluminum foil, urethane-free adhesive, or polypropylene. FIG. 10B shows an exemplary pouch cell 1011 with an extra sealing bag area 1012. The extra sealing bag area may comprise a resealable cap 1013, which can be resealed after the rejuvenation process. The resealable cap may comprise chloroprene rubber, nitrile rubber, silicone rubber, stainless steel, polypropylene, or combinations thereof. FIG. 11A shows an exemplary prismatic cell with a resealable cap. The prismatic cell 1101 may have a screw cap 1102 on the side of the cell. In some embodiments, the resealable cap may comprise a material of nitrile butadiene rubber or polyurethane. The cap 1102 can be opened for solvent or electrolyte injection and removal of aged electrolyte. FIG. 11B shows another exemplary prismatic cell with a resealable cap. The prismatic cell 1111 may have a screw cap ring 1112 in the middle of the cell. A portion of the cell shell may be taken off for rejuvenation of the cell and after the rejuvenation, the shell may be placed back and resealed with a material, e.g., a thermoplastic material. The material (e.g., sealing bag and/or resealable cap) may be selected for the requirements of mechanical strength at different aging times and elevated temperatures, sealing reliability, Young's modulus, flexibility, and resistance to deformation across varying temperatures and electrolytes.

### Acoustic Device

An acoustic device as described herein can refer to any apparatus, device, or system that is designed, configured, or used for transmitting acoustic waves into the energy device.

In some embodiments, the acoustic device can enclose an acoustic wave generator. In some embodiments, the acoustic wave generator can comprise a piezoelectric material. In some embodiments, the piezoelectric material can include lithium niobate (LiNbO₃), lithium titanate (Li₂TiO₃), barium titanate (BaTiO₃), lead zirconate titanate (Pb(ZrₓTi₁₋ₓ)O₃ wherein (0≤x≤1)), quartz, aluminum nitride (AlN), langasite, lead magnesium niobate-lead titanate (PMN-PT), lead-free potassium sodium niobate (K_{0.5}Na_{0.5}NbO₃ or KNN), a doped derivative of lead-free potassium sodium niobate, and/or polyvinylidene fluoride (PVDF).

In some embodiments, the acoustic device can comprise a transducer. In some embodiments, the transducer may be configured to respond to an electrical input signal by at least applying tension and compression within and/or upon the substrate. The substrate may respond to the tension and the compression by at least oscillating to generate the plurality of acoustic waves. In some embodiments, the transducer may be configured to isolate the acoustic waves to a surface of the energy device, increase maximum vibrational amplitude for a given voltage signal, and/or generate a large vibrational amplitude at a relatively low frequency. In some embodiments, the transducer is configured occupy minimal lateral space on the electrochemical device. In some embodiments, the transducer may comprise a conductive material. In some embodiments, the transducer may comprise a metal selected from the group consisting of titanium, aluminum, copper, chromium, gold, nickel, and/or tin. In some embodiments, the transducer can be patterned onto a substrate to form an acoustic device for various applications. In some embodiments, the transducer may comprise one or more pairs of interdigital transducers, thickness mode transducer, and lamb wave transducer. In some embodiments, the transducer may comprise one or more contact pins. In some embodiments, the interdigital transducer may comprise a straight finger interdigital transducer (SIDT) or a focused interdigital transducer (FIDT). In some embodiments, the transducer can be deposited on the substrate.

In some embodiments, the acoustic device can comprise a housing. In some embodiments, the housing can be made of a material that allows acoustic waves from the acoustic wave generator to transmit through. In some embodiments, the housing can enable safe storage of the acoustic wave generator, which, in turn, makes the acoustic device portable. In some embodiments, the housing can provide separation between the acoustic wave generator and the controller. In some embodiments, the housing can propagate the generated waves from the acoustic wave generator outward from the acoustic device. In some embodiments, the housing can interface with the energy device via an external surface of the energy device. In some embodiments, the housing can be open at one end. In some embodiments, the open end may be coupled to the energy device. In some embodiments, when the open end is coupled to the energy device, the acoustic waves, e.g., surface acoustic waves, may directly propagate into the energy device. In some embodiments, the housing can be closed at the one end such that the housing wholly encloses the acoustic device.

In some embodiments, multiple acoustic devices can be integrated into an acoustic module. In some embodiments, the acoustic module can comprise a controller. The controller can be in electronic communication with the acoustic device. The controller can modulate or control the output of the acoustic device, such as the generated acoustic waves. The controller can manipulate a generated frequency, power, attenuation length, and/or other parameters of the acoustic waves. The controller can simultaneously control the outputs of multiple acoustic devices within the acoustic module.

In some embodiments, the at least one acoustic device can be coupled to (e.g., mounted to) an energy device. In some embodiments, the at least one acoustic device can be coupled to an exterior of the energy device. In some embodiments, the at least one acoustic device can be coupled to an interior of the energy device. In some embodiments, the at least one acoustic device can be attached to one or more suitable or predefined locations on the energy device.

In some embodiments, the at least one acoustic device can interface with at least two external surfaces of the energy device. In some embodiments, the at least two external surfaces can be parallel to each other. In some embodiments, the at least two external surfaces can be opposite to one another. In some embodiments, the at least two external surfaces can be orthogonal to one another.

In some embodiments, a plurality of acoustic devices can be used to generate acoustic waves in a plurality of directions (e.g., parallel and/or orthogonal to the direction of Lit migration).

In some embodiments, a plurality of acoustic devices may be in communication with the energy device. In some embodiments, one or more coupling agents can be used to secure the acoustic device to the energy device during the rejuvenation. In some embodiments, the coupling agent can establish a connection between the housing of the acoustic device and the energy device. In some embodiments, the coupling agent can be a chemical agent. In some embodiments, the coupling agent can comprise a liquid, a gel, or a paste. In some embodiments, the coupling agent can be moderately viscous and nontoxic. In some embodiments, the coupling agent can comprise silicone grease. In some embodiments, the acoustic wave may be coupled through an ultrasound gel into the energy device, generating acoustic streaming inside the energy device. In some embodiments, the coupling agent can be a physical mechanism, e.g., magnetic coupling or mechanical coupling, e.g., by compression. In some embodiments, the coupling agent can partially or entirely fill a gap between the energy device and the acoustic device. In some embodiments, the coupling agent can be aligned with the acoustic device. In some embodiments, the coupling agent may not be aligned with the acoustic device.

In some embodiments, the orientation, location, number, and/or operation frequency of the acoustic device may be adjusted accordingly relative to the energy device in order to effectively agitate electrolyte over the energy device and/or electrodes, regardless of the form factor of the energy device.

In some embodiments, the acoustic device can be tuned to emit acoustic waves of specific frequencies, amplitudes, and durations, making it adaptable to different energy device types and sizes. In some embodiments, the acoustic waves can be customized or tuned based at least in part on a type, capacity, function, shape, size, form factor, and/or operating conditions of the energy device.

In some embodiments, the acoustic waves can propagate (e.g., stream) in a plurality of directions. Within an energy device, the acoustic waves may propagate along one axis, two axes, or three axes of the energy device. In some embodiments, the acoustic waves may be propagated coaxially, parallel, antiparallel, orthogonal, or a combination thereof, to the direction of cation (e.g., Li⁺, Na⁺, Mg²⁺, Zn⁺) flow. Cations can flow along a length (e.g., a y-axis) of the energy device, such as along an electrode gap in the energy device. The direction of cation flow may be parallel to or orthogonal to the direction of the acoustic waves.

In some embodiments, the energy of the acoustic waves may induce acoustic streaming in the energy device. In some embodiments, acoustic streaming may be a non-laminar and/or turbulent fluid flow, which may maximize the agitation of the electrolyte and/or the homogenization of the distribution of the cations in the electrolyte. In some embodiments, acoustic streaming may result from the interplay between variations in the density of the electrolyte and variations in the velocity of the electrolyte. In some embodiments, a frequency of the acoustic waves, an amplitude of the acoustic waves, and/or the viscosity of the electrolyte may determine whether the acoustic waves are able to induce acoustic streaming in the electrolyte. In some embodiments, acoustic streaming may be achieved at lower frequencies of the acoustic waves, for example, when the viscosity of the electrolyte is between a certain range. For example, acoustic streaming may be induced in water, which may have a viscosity of 0.890 centipoise at 25° C., when the frequency of the acoustic waves exceeds 1 megahertz (1 MHz).

In some embodiments, the acoustic waves can have one or more waveforms selected from the group consisting of a continuous sine wave, square wave, and triangular wave.

In some embodiments, the acoustic waves can comprise at least one of the following: surface acoustic waves (SAW), Lamb waves, Love waves, flexural waves, thickness mode vibrations, mixed-mode waves, longitudinal waves, shear mode vibrations, bulk wave vibrations, standing wave vibrations, or any combination(s) thereof.

In some embodiments, the acoustic waves can have a fixed frequency during the rejuvenation. In some embodiments, the frequency of the acoustic waves can be varied during the rejuvenation. In some embodiments, the frequency of the acoustic waves can be increased during the rejuvenation. In some embodiments, the frequency of the acoustic waves can be reduced during the rejuvenation. In some embodiments, the frequency of the acoustic waves can be first increased and then reduced during the rejuvenation. In some embodiments, the frequency of the acoustic waves can be first reduced and then increased during the rejuvenation. In some embodiments, the frequency or the change of frequency can be based on the state of the energy device (e.g., electrolyte loss, capacity loss, CEI and SEI thickness, etc.). In some embodiments, the frequency or the change of frequency can be based on the conditions of the rejuvenation process (e.g., flow rate of electrolytes, required volume of electrolytes, required restoration level, etc.). In some embodiments, the acoustic waves can have a frequency ranging from 10 hertz (Hz) to 500 megahertz (MHz). In some embodiments, the frequency of the acoustic waves can range from about 10 Hz to about 100 Hz, from about 10 Hz to about 1 kilohertz (kHz), from about 10 Hz to about 10 kHz, from about 10 Hz to about 100 kHz, from about 10 Hz to about 1 MHz, from about 10 Hz to about 100 MHz, from about 10 Hz to about 500 MHz, from about 100 Hz to about 1 kHz, from about 100 Hz to about 10 kHz, from about 100 Hz to about 100 kHz, from about 100 Hz to about 1 MHz, from about 100 Hz to about 100 MHz, from about 100 Hz to about 500 MHz, from about 1 kHz to about 10 kHz, from about 1 kHz to about 100 kHz, from about 1 kHz to about 1 MHz, from about 1 kHz to about 100 MHz, from about 1 kHz to about 500 MHz, from about 10 kHz to about 100 kHz, from about 10 kHz to about 1 MHz, from about 10 kHz to about 100 MHz, from about 10 kHz to about 500 MHz, from about 100 kHz to about 1 MHz, from about 100 kHz to about 100 MHz, from about 100 kHz to about 500 MHz, from about 1 MHz to about 100 MHz, from about 1 MHz to about 500 MHz, or from about 100 MHz to about 500 MHz. The frequency (fₛ) of the generated acoustic waves may be selected based on a desired length of the acoustic waves, as determined by the equation:

$${λ}_{AW} = \frac{{c}_{s}}{{f}_{s}} \qquad ( eq . 1 )$$

wherein cₛ corresponds to the speed of light traveling through the medium (e.g., an electrode or an electrolyte of the energy device, or other components of the present disclosure) and λ_{AW} corresponds to a wavelength of the acoustic waves.

In some embodiments, the acoustic waves can have a fixed power during the rejuvenation. In some embodiments, the power of the acoustic waves can be varied during the rejuvenation. In some embodiments, the power of the acoustic waves can be increased during the rejuvenation. In some embodiments, the power of the acoustic waves can be reduced during the rejuvenation. In some embodiments, the power of the acoustic waves can be first increased and then reduced during the rejuvenation. In some embodiments, the power of the acoustic waves can be first reduced and then increased during the rejuvenation. In some embodiments, the power or the change of power can be based on the state of the energy device (e.g., electrolyte loss, capacity loss, CEI and SEI thickness, etc.). In some embodiments, the power or the change of power can be based on the conditions of the rejuvenation process (e.g., flow rate of electrolytes, required volume of electrolytes, required restoration level, etc.). In some embodiments, the acoustic waves can have a power ranging from 0.1 milliwatts (mW) to 500 megawatts (MW). In some embodiments, the power of the generated acoustic waves can range from about 0.1 mW to about 1 mW, from about 0.1 mW to about 1 W, from about 0.1 mW to about 10 W, from about 0.1 mW to about 100 W, from about 0.1 mW to about 1 kilowatt (kW), from about 0.1 mW to about 10 KW, from about 0.1 mW to about 100 KW, from about 0.1 mW to about 1 MW, from about 1 mW to about 1 W, from about 1 mW to about 10 W, from about 1 mW to about 100 W, from about 1 mW to about 1 kW, from about 1 mW to about 10 KW, from about 1 mW to about 100 KW, from about 1 mW to about 1 MW, from about 1 W to about 10 W, from about 1 W to about 100 W, from about 1 W to about 1 kW, from about 1 W to about 10 KW, from about 1 W to about 100 KW, from about 1 W to about 1 MW, from about 10 W to about 100 W, from about 10 W to about 1 kW, from about 10 W to about 10 KW, from about 10 W to about 100 KW, from about 10 W to about 1 MW, from about 100 W to about 1 kW, from about 100 W to about 10 kW, from about 100 W to about 100 KW, from about 100 W to about 1 MW, from about 1 kW to about 10 KW, from about 1 kW to about 100 KW, from about 1 kW to about 1 MW, from about 10 kW to about 100 KW, from about 10 kW to about 1 MW, or from about 100 KW to about 1 MW.

In some embodiments, the acoustic waves can be generated with on/off pulsing ranging from 0% to 100%. In some embodiments, the acoustic waves are generated with on/off pulsing ranging from about 0% to about 10%, from about 0% to about 20%, from about 0% to about 30%, from about 0% to about 40%, from about 0% to about 50%, from about 0% to about 60%, from about 0% to about 70%, from about 0% to about 80%, from about 0% to about 90%, from about 0% to about 100%, from about 10% to about 20%, from about 10% to about 30%, from about 10% to about 40%, from about 10% to about 50%, from about 10% to about 60%, from about 10% to about 70%, from about 10% to about 80%, from about 10% to about 90%, from about 10% to about 100%, from about 20% to about 30%, from about 20% to about 40%, from about 20% to about 50%, from about 20% to about 60%, from about 20% to about 70%, from about 20% to about 80%, from about 20% to about 90%, from about 20% to about 100%, from about 30% to about 40%, from about 30% to about 50%, from about 30% to about 60%, from about 30% to about 70%, from about 30% to about 80%, from about 30% to about 90%, from about 30% to about 100%, from about 40% to about 50%, from about 40% to about 60%, from about 40% to about 70%, from about 40% to about 80%, from about 40% to about 90%, from about 40% to about 100%, from about 50% to about 60%, from about 50% to about 70%, from about 50% to about 80%, from about 50% to about 90%, from about 50% to about 100%, from about 60% to about 70%, from about 60% to about 80%, from about 60% to about 90%, from about 60% to about 100%, from about 70% to about 80%, from about 70% to about 90%, from about 70% to about 100%, from about 80% to about 90%, from about 80% to about 100%, or from about 90% to about 100%.

In some embodiments, the acoustic waves can be generated with a timescale period ranging from about 1 microsecond (μs) to about 1 millisecond (ms). In some embodiments, the timescale period can range from about 1 μs to about 10 μs, from about 1 μs to about 50 μs, from about 1 μs to about 100 μs, from about 1 μs to about 250 μs, from about 1 μs to about 500 μs, from about 1 μs to about 750 μs, from about 1 μs to about 1 ms, from about 10 μs to about 50 μs, from about 10 μs to about 100 μs, from about 10 μs to about 250 μs, from about 10 μs to about 500 μs, from about 10 μs to about 750 μs, from about 10 μs to about 1 ms, from about 50 μs to about 100 μs, from about 50 μs to about 250 μs, from about 50 μs to about 500 μs, from about 50 μs to about 750 μs, from about 50 μs to about 1 ms, from about 100 μs to about 250 μs, from about 100 μs to about 500 μs, from about 100 μs to about 750 μs, from about 100 μs to about 1 ms, from about 250 μs to about 500 μs, from about 250 μs to about 750 μs, from about 250 μs to about 1 ms, from about 500 μs to about 750 μs, from about 500 μs to about 1 ms, or from about 750 μs to about 1 ms. In some embodiments, the timescale period can be about 1 μs, about 10 μs, about 50 μs, about 100 μs, about 250 μs, about 500 μs, about 750 μs, or about 1 ms.

### Computer Systems

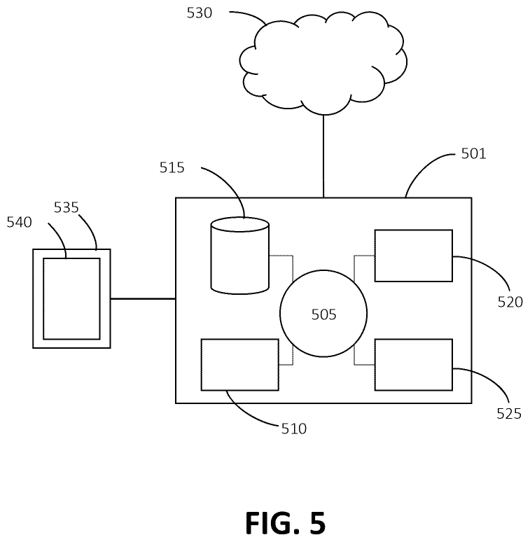

The present disclosure provides computer systems that are programmed to implement methods of the disclosure. FIG. 5 shows a computer system 501 that is programmed or otherwise configured to control an output from a device, system, or apparatus according to the embodiments disclosed herein. For example, the computer system 501 may be configured to control an output from an acoustic device or an energy device as described herein. The computer system 501 can regulate various aspects of generating acoustic waves of the present disclosure, such as, for example, frequency, wavelength, amplitude, or power, types of waveforms. The computer system 501 can be an electronic device of a user or a computer system that is remotely located with respect to the acoustic device or acoustic module according to the disclosure. The electronic device can be a mobile electronic device.

The computer system 501 includes a central processing unit (CPU, also “processor” and “computer processor” herein) 505, which can be a single core or multi-core processor, or a plurality of processors for parallel processing. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520, and peripheral devices 525 are in communication with the CPU 505 through a communication bus (solid lines), such as a motherboard. The storage unit 515 can be a data storage unit (or data repository) for storing data. The computer system 501 can be operatively coupled to a computer network (“network”) 530 with the aid of the communication interface 520. The network 530 can be the Internet, an intranet, and/or extranet, or an intranet and/or extranet that is in communication with the Internet. The network 530, in some cases, is a telecommunication and/or data network.

The network 530 can include one or more computer servers, which can enable distributed computing, such as cloud computing. The network 530, in some cases with the aid of the computer system 501, can implement a peer-to-peer network, which may enable devices coupled to the computer system 501 to behave as a client or a server.

The CPU 505 can execute a sequence of machine-readable instructions, which can be embodied in a program or software. The instructions may be stored in a memory location, such as the memory 510. The instructions can be directed to the CPU 505, which can subsequently program or otherwise configure the CPU 505 to implement methods of the present disclosure. Examples of operations performed by the CPU 505 can include fetch, decode, execute, and writeback.

The CPU 505 can be part of a circuit, such as an integrated circuit. One or more other components of the system 501 can be included in the circuit. In some cases, the circuit is an application-specific integrated circuit (ASIC).

The storage unit 515 can store files, such as drivers, libraries, and saved programs. The storage unit 515 can store user data, e.g., user preferences and user programs. The computer system 501, in some cases, can include one or more additional data storage units that are external to the computer system 501, such as located on a remote server that is in communication with the computer system 501 through an intranet or the Internet.

The computer system 501 can communicate with one or more remote computer systems through the network 530. For instance, the computer system 501 can communicate with a remote computer system of a user (e.g., a personal health device, laptop, monitoring device, or any other device commonly used by a health practitioner). Examples of remote computer systems include personal computers (e.g., portable PC), slate or tablet PC's (e.g., Apple® iPad, Samsung® Galaxy Tab), telephones, smartphones (e.g., Apple® iphone, Android-enabled device, Blackberry®), or personal digital assistants. The user can access the computer system 501 via the network 530.

Methods as described herein can be implemented by way of machine (e.g., computer processor) executable code stored on an electronic storage location of the computer system 501, such as, for example, on the memory 510 or electronic storage unit 515. The machine executable or machine-readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine-readable medium.

Machine-executable code can be stored on an electronic storage unit, such as memory (e.g., read-only memory, random-access memory, flash memory) or a hard disk. “Storage” type media can include any or all of the tangible memory of the computers, processors, or the like, or associated modules thereof, such as various semiconductor memories, tape drives, disk drives, and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as those used across physical interfaces between local devices, through wired and optical landline networks, and over various air-links. The physical elements that carry such waves, such as wired or wireless links, optical links, or the like, may also be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium, or a physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables, copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer-readable media may be involved in carrying one or more sequences of one or more instructions to a processor for execution.

The computer system 501 can include or be in communication with an electronic display 535 that comprises a user interface (UI) 540 for providing. Examples of UI's include, without limitation, a graphical user interface (GUI) and a web-based user interface.

Methods and systems of the present disclosure can be implemented by way of one or more algorithms. An algorithm can be implemented by way of software upon execution by the central processing unit 505.

### EXAMPLES

### Example 1: Lithium Iron Phosphate (LiFePO₄ or LFP) Cylindrical Cell Rejuvenation

This example demonstrates the effects of acoustic devices in the rejuvenation process of an energy device, e.g., a lithium iron phosphate (LiFePO₄ or LFP) cylindrical cell.

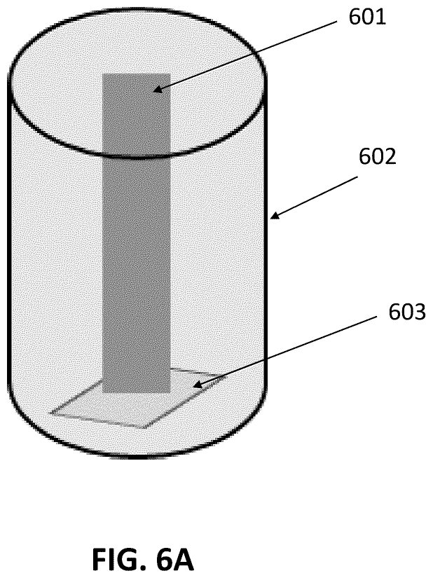

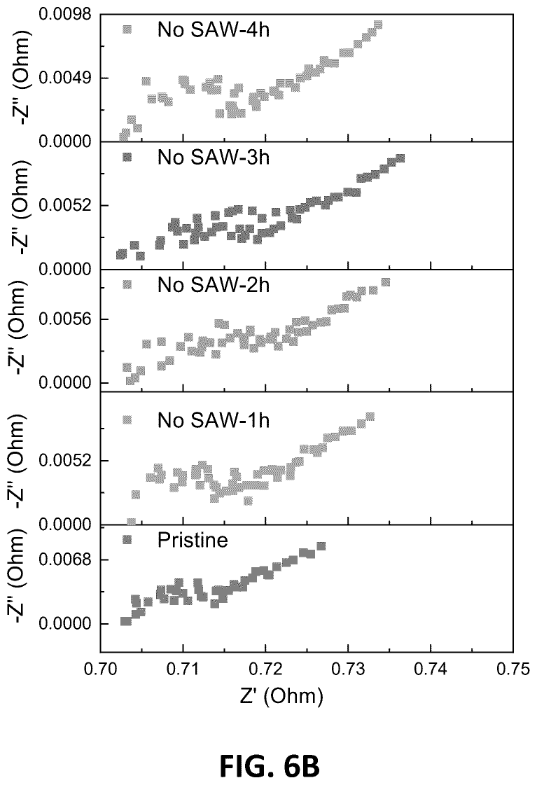

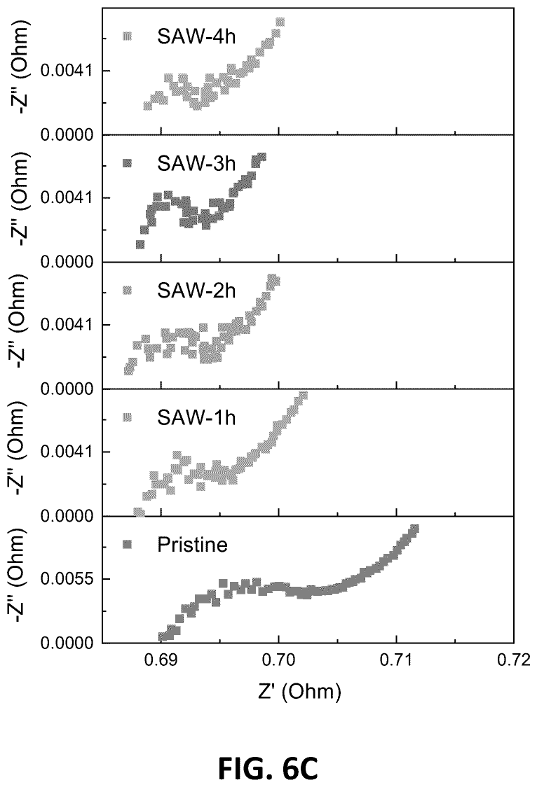

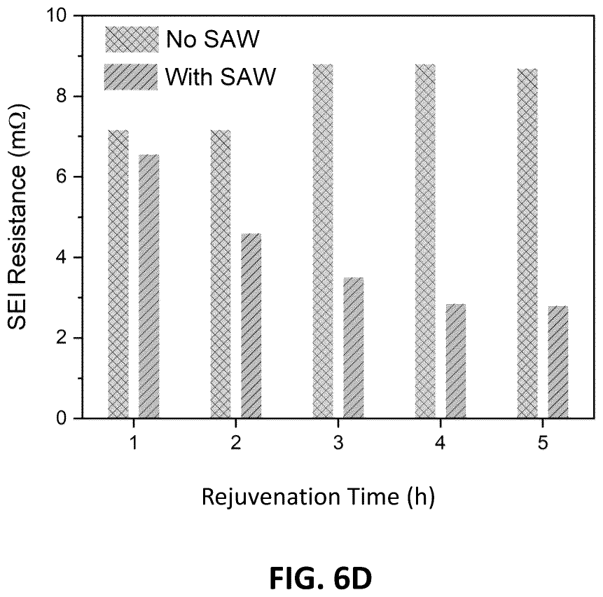

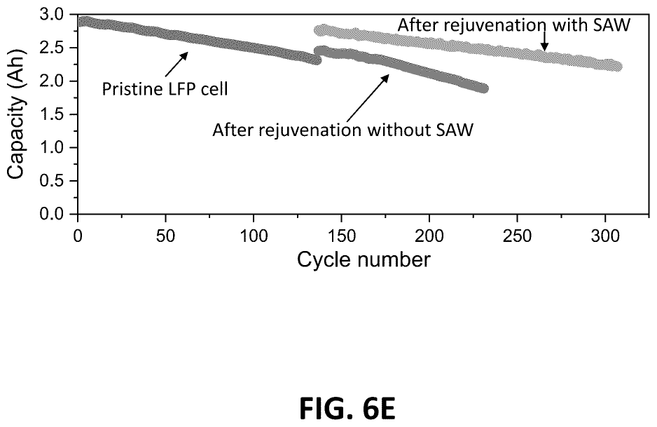

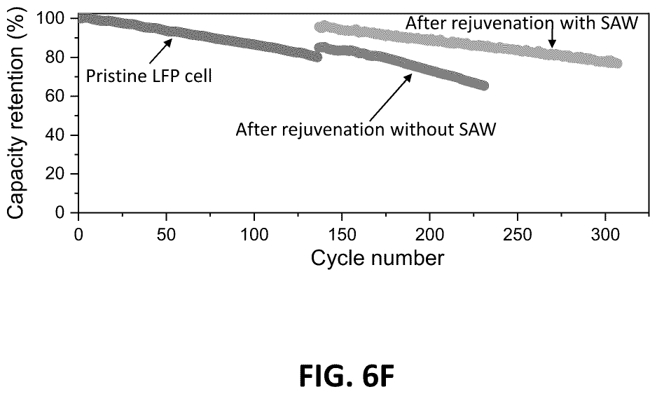

A 3 Ah LFP cylindrical cell was used at 1.0 C cycle until the capacity retention was below 80%. FIG. 6A shows an exemplary setup for the rejuvenation process. The LFP cylindrical cell 601 with an open bottom was placed in a container 602 comprising fresh electrolyte. An acoustic device 603 (e.g., a SAW device) was coupled to the cell 601. The rejuvenation was performed with and without the acoustic waves.

FIG. 6B shows the electrochemical impedance spectroscopy (EIS) test results at different rejuvenation time for the cell rejuvenated without SAW (“No SAW”). FIG. 6C shows the EIS test results at different rejuvenation time for the cell rejuvenated with SAW. The cell rejuvenated with SAW had decreased SEI resistance. “Pristine” refers to the fresh cell.

FIG. 6D shows the SEI resistance of the cell after different rejuvenation time with (“With SAW”) and without SAW (“No SAW”) device. For the rejuvenation without SAW, the SEI resistance increased from 2 h to 3 h, which was likely due to a side reaction that caused the SEI resistance to increase. The SEI resistance of the cell rejuvenated with SAW was significantly lower than SEI resistance of the cell rejuvenated without SAW. Further, the SEI resistance of the cell rejuvenated with SAW was decreased by about 57% after rejuvenation.

FIG. 6E shows the capacity of the pristine cell, the cell rejuvenated with SAW, and the cell rejuvenated without SAW, during charge and discharge cycling. FIG. 6F shows the capacity retention (capacity divided by the original capacity or maximum capacity) of the pristine cell, the cell rejuvenated with SAW, and the cell rejuvenated without SAW, during charge and discharge cycling. The capacity of pristine LFP cell decayed from 2.89 Ah to 2.31 Ah after 136 cycles (80% reduction in capacity). After rejuvenation with SAW, the capacity was recovered to 2.76 Ah (95.6% of the pristine cell). After rejuvenation without SAW, the capacity was recovered to 2.45 Ah (85% of the pristine cell).

Cycling stability of the LFP cell after rejuvenation with SAW was better than that of the pristine cell (26% improvement). Cycling stability is based on the capacity delivered at a certain cycle number and the first cycle capacity. After the rejuvenation, the SEI and CEI layers formed were more uniform than the pristine cell, thereby resulting in improved cycling stability. Cycling stability of the LFP cell after rejuvenation with SAW was better than that of the LFP cell after rejuvenation without SAW (80% improvement).

### Example 2: Nickel-Cobalt-Manganese (NCM) Cylindrical Cell Rejuvenation

This example demonstrates the effects of acoustic devices in the rejuvenation process of an energy device, e.g., a Nickel-Cobalt-Manganese (NCM) cylindrical cell.

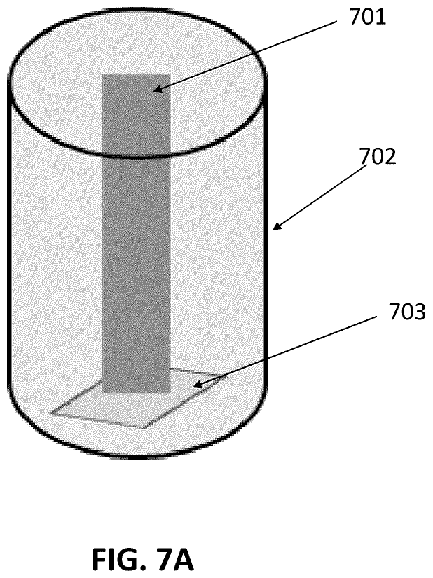

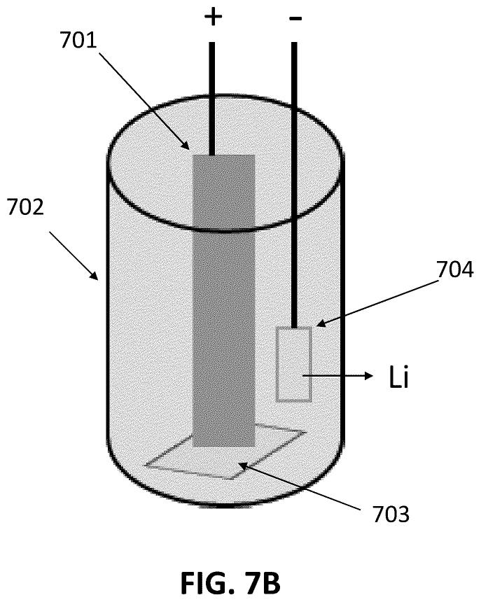

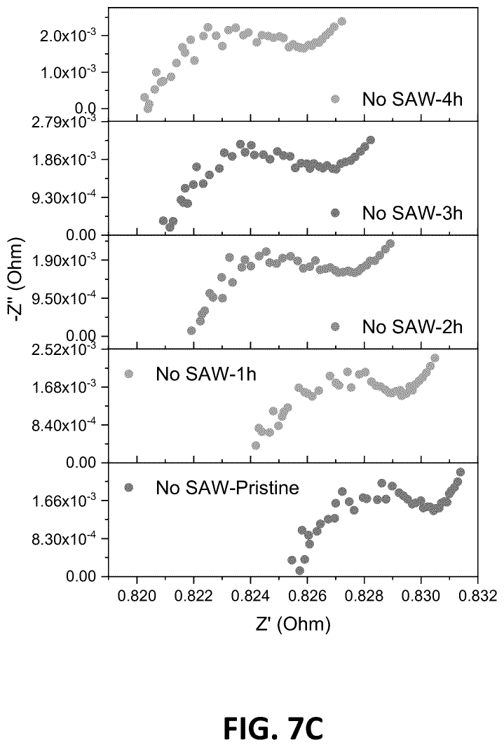

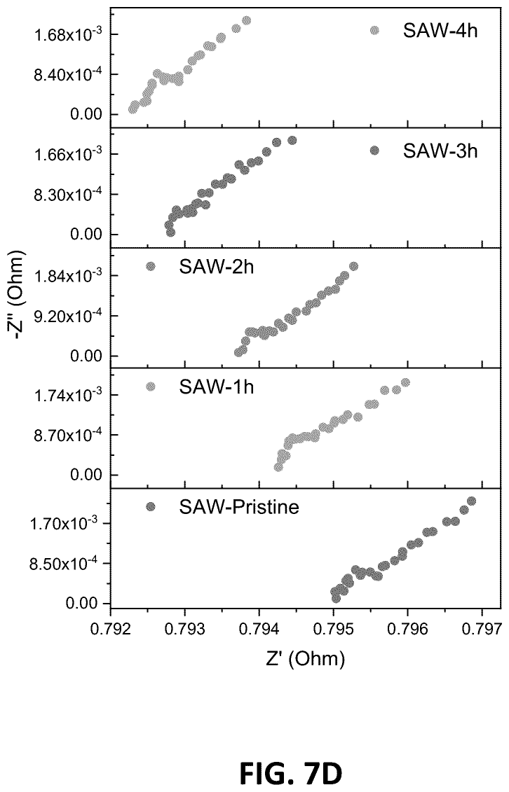

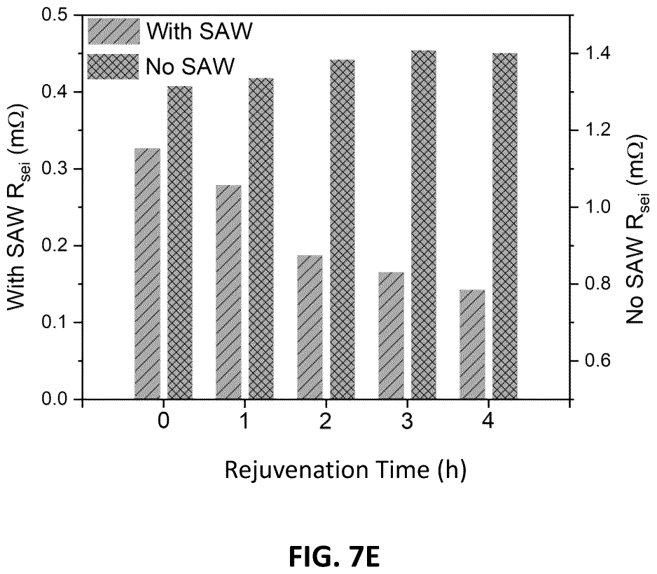

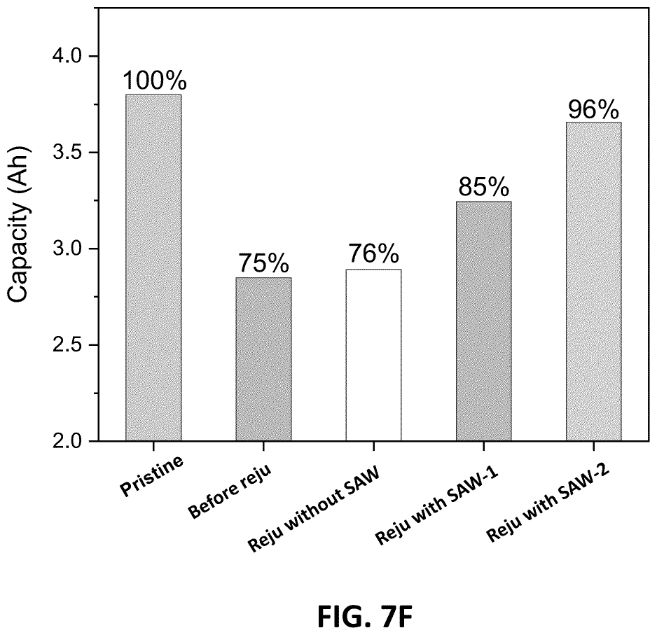

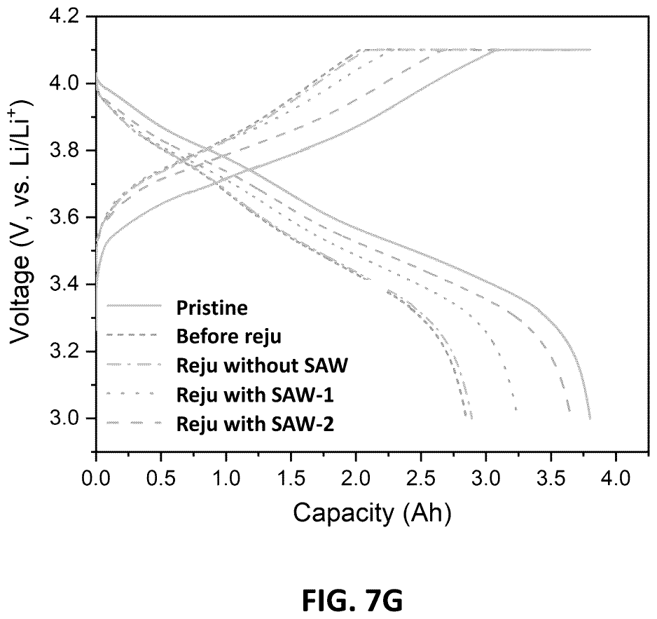

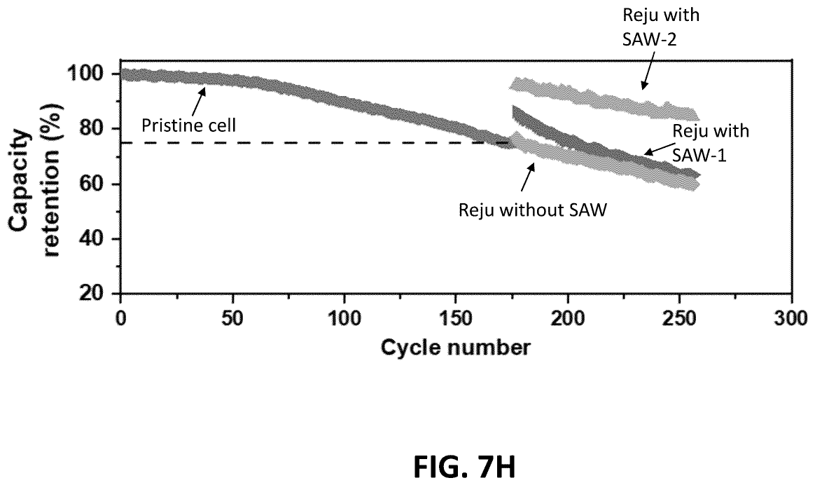

A 3.8 Ah NCM cylindrical cell was used at a discharge/charge rate of 0.5 C/1.0 C cycle until the capacity retention was below 75%. FIG. 7A shows an exemplary setup for the rejuvenation process. The NCM cylindrical cell 701 with an open bottom was placed in a container 702 comprising fresh electrolyte. An acoustic device 703 (e.g., a SAW device) was coupled to the cell. The rejuvenation was performed with and without the acoustic waves. FIG. 7B shows an exemplary setup for an electrochemical lithiation to further replenish the electrode with Li ions. The electrochemical lithiation process comprises discharging the cell's positive end against a piece of lithium (704) for 1 hour.

FIG. 7C shows the EIS test results at different rejuvenation time for the cell rejuvenated without SAW. FIG. 7D shows the EIS test results at different rejuvenation time for the cell rejuvenated with SAW. The cell rejuvenated with SAW had decreased SEI resistance.

FIG. 7E shows the SEI resistance of the cell after different rejuvenation time with (“With SAW”) and without SAW (“No SAW”). The SEI resistance of the cell rejuvenated with SAW was significantly lower than SEI resistance of the cell rejuvenated without SAW. Further, the SEI resistance of the cell rejuvenated with SAW was decreased by about 60% after rejuvenation.

FIG. 7F shows the capacity of the pristine cell, used cell (“Before reju”), cell rejuvenated without SAW (“Reju without SAW”), cell rejuvenated with SAW (“Reju with SAW-1”), and cell rejuvenated with SAW and further Li replenishment in the cathode (“Reju with SAW-2”). Rejuvenation without SAW increased the capacity by about 1%. Rejuvenation with SAW increased the capacity by about 10%, and further Li ion replenishment (lithiation) increased the capacity by about 21%.

FIG. 7G shows the 1^{st} discharge curves at 0.5 C discharge rate and the 1^{st} charge curves at 1.0 C charge rate for the pristine cell, used cell (“Before reju”), cell rejuvenated without SAW (“Reju without SAW”), cell rejuvenated with SAW (“Reju with SAW-1”), and cell rejuvenated with SAW and further Li ion replenishment (“Reju with SAW-2”). The cells rejuvenated with SAW exhibited more favorable kinetics due to the higher discharge voltage than the used cell and the cell rejuvenated without SAW, indicating lower overpotential and higher energy density of the cells rejuvenated with SAW. The cells rejuvenated with SAW exhibited higher charge capacity and lower charge voltage than the used cell and the cell rejuvenated without SAW, indicating lower overpotential and higher energy efficiency of the cells rejuvenated with SAW. Li ion replenishment further increased the energy density and energy efficiency.

FIG. 7H shows the capacity retention of the pristine cell (“Pristine cell”), cell rejuvenated without acoustic waves (“Reju without SAW”), cell rejuvenated with acoustic waves (“Reju with SAW-1”), and cell rejuvenated with waves and further Li ion replenishment (“Reju with SAW-2”). The cycling stability and capacity retention of cells after rejuvenation with SAW was much better than the cells rejuvenated without the acoustic device. Li ion replenishment further increased the cycling stability and cycling capacity.

### Example 3: In-Situ Rejuvenation

This example demonstrates the in-situ rejuvenation with acoustic waves.

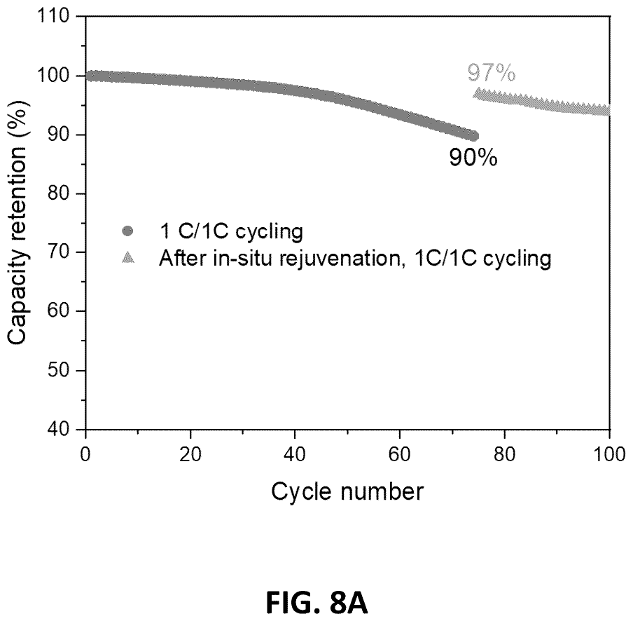

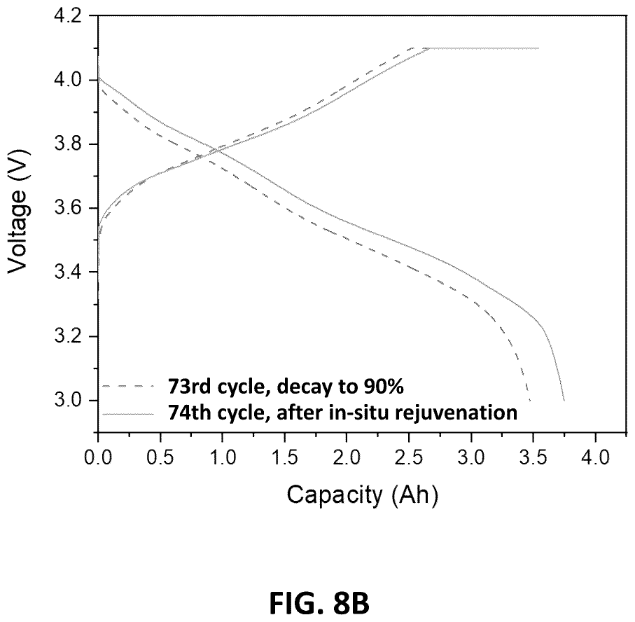

A 5.0 Ah 21700 cell was used at a discharge/charge rate of 1.0 C/1.0 C CCCV cycling until the capacity retention was about 90% (after 73 cycles). An acoustic wave was coupled to the cell and acoustic waves were applied to the cell for in situ rejuvenation without opening the cell. After 2 days of the in-situ rejuvenation with SAW, the capacity of the cell was recovered to about 97%. FIG. 8A shows the capacity retention of the pristine cell during the cycling (“1C/1C cycling”) and the rejuvenated cell during a 1.0 C/1.0 C CCCV cycling (“After in-situ rejuvenation, 1.0 C/1.0 C CCCV cycling”). FIG. 8B shows the voltage and capacity of 73^{rd} discharge/charge cycle and the 74^{th} discharge/charge cycle. The cell at the 73^{rd} cycle had a capacity of 90% of the pristine cell. The cell at the 74^{th} cycle was the first cycle after the in-situ rejuvenation, and the capacity was about 97% of the pristine cell. This in-situ rejuvenation procedure is to recover the cell performance without opening the cell and extend the cycling life. The in-situ rejuvenation can be used in combination with a rejuvenation thereafter, which opens the cell to replenish with fresh electrolyte.

While preferred embodiments of the present disclosure have been shown and described herein, such embodiments are provided by way of example only. Numerous variations, changes, and substitutions can occur without departing from the disclosure. It can be understood that various alternatives to the embodiments of the present disclosure may be employed in practicing the present disclosure. It is intended that the following claims define the scope of the present disclosure and that methods and structures within the scope of these claims and their equivalents be covered thereby.

1. A method for rejuvenating an energy device, the method comprising:
using at least one acoustic device to generate acoustic waves to facilitate flow and/or distribution of fresh or unused chemicals into the energy device and to replenish, replace, and expel aged or used chemicals out of the energy device, thereby rejuvenating the energy device and rendering the energy device suitable for continued usage, wherein:
the energy device comprises one or more electrochemical cells,
the aged or used chemicals comprise a used electrolyte,
the fresh or unused chemicals comprise a fresh unused electrolyte, and
rejuvenating the energy device comprises increasing a capacity of the energy device by at least 1%.

2. The method of claim 1, wherein the energy device has less than 60% of an original capacity prior to the rejuvenating and greater than 60% of the original capacity after the rejuvenating.

3. The method of claim 1, wherein the aged or used chemicals are provided in a semi-solid form factor, a gel form factor, or a liquid form factor.

4. The method of claim 1, wherein the fresh or unused chemicals are provided in a semi-solid form factor, a gel form factor, or a liquid form factor.

5. The method of claim 1, further comprising using the at least one acoustic device to generate acoustic waves to reduce an amount, thickness, or non-uniformity of one or more interphase layers within the energy device.

6. The method of claim 5, wherein the interphase layers comprise a solid electrolyte interphase (SEI) and a cathode electrolyte interphase (CEI).

7. The method of claim 1, further comprising using the at least one acoustic device to generate and stream the acoustic waves to replenish ions to a positive electrode or a negative electrode of the energy device to restore an ionic concentration within the energy device.

8. The method of claim 7, wherein the ions are replenished to the positive electrode or the negative electrode of the energy device via intercalation, conversion, alloying, or plating.

9. The method of claim 1, wherein the energy device comprises one or more inlets and one or more outlets, and wherein the aged or used chemicals are expelled from the energy device through the one or more outlets, and the fresh or unused chemicals are flown into the energy device through the one or more inlets.

10. The method of claim 9, wherein one or more outlets comprise a resealable opening.

11. The method of claim 9, wherein one or more inlets comprise a resealable opening.

12. The method of claim 9, wherein the one or more inlets comprise a first resealable opening, and the one or more outlets comprise a second resealable opening.

13. The method of claim 9, wherein the one or more inlets and the one or more outlets are located at opposite ends, or the same ends, or at any locations on the cell of the energy device.

14. The method of claim 1, wherein the acoustic waves comprise at least one of the following: surface acoustic waves (SAW), Lamb waves, Love waves, flexural waves, thickness mode vibrations, mixed-mode waves, longitudinal waves, shear mode vibrations, bulk wave vibrations, standing wave vibrations, or any combination(s) thereof.

15. The method of claim 1, wherein the at least one acoustic device is attached to an exterior of the energy device.

16. The method of claim 1, wherein a frequency of the acoustic waves is varied.

17. The method of claim 1, wherein the power of the acoustic waves is varied.

18. The method of claim 1, further comprising expelling the aged or used chemicals out of the energy device with a solvent.

19. The method of claim 18, further comprising flowing fresh or unused chemicals into the energy device subsequent to the expelling the aged or used chemicals.

20. The method of claim 1, wherein rejuvenating the energy device is performed without opening the one or more electrochemical cells of the energy device.
